(19) United States
(12) Patent Application Publication
(10) Pub. No.: US 2026/0062528 A1
(43) Pub. Date: Mar. 5, 2026

(54) HYDROPHILIC AND HYDROPHOBIC POROUS ELASTOMERS

(71) Applicant: Colorado State University Research Foundation, Fort Collins, CO (US)

(72) Inventors: Travis S. Bailey, Fort Collins, CO (US); William B. Morris, Fort Collins, CO (US)

(73) Assignee: Colorado State University Research Foundation, Fort Collins, CO (US)

(21) Appl. No.: 19/105,320

(22) PCT Filed: Aug. 22, 2023
(86) PCT No.: PCT/US2023/030805

§ 371 Date: Feb. 20, 2025

Related U.S. Application Data
(60) Provisional application No. 63/399,951, filed on Aug. 22, 2022.

(51) Int. Cl. C08J 9/00; C08G 81/02; C08J 3/09; C08J 3/24; C08J 9/36

(52) U.S. Cl. CPC C08J 9/0061; C08G 81/025; C08J 3/092; C08J 3/245; C08J 3/247; C08J 9/365; C08J 2325/18; C08J 2353/00; C08J 2371/02

(57) ABSTRACT

The present disclosure provides a porous elastomer, methods of preparing the porous elastomer, and methods of using the porous elastomers. The porous elastomers described herewith may be hydrophilic and hydrophobic porous elastomers derived from a TPPE precursor composite.

### CROSS REFERENCE TO RELATED APPLICATIONS

This application claims priority to U.S. Provisional Patent Application Ser. No. 63/399,951, filed Aug. 22, 2022, the contents of which is hereby incorporated by reference for all purposes in its entirety.

### GOVERNMENT SUPPORT

This invention was made with government support under grant 1808824 awarded by the National Science Foundation. The government has certain rights in the invention.

### FIELD

The present disclosure relates to thermoplastic porous elastomer (TPPE) precursor composite, methods of preparing the TPPE precursor composites, hydrophilic and hydrophobic porous elastomers formed from the TPPE precursor composites, methods of forming the porous elastomers, and methods of using hydrophilic and hydrophobic porous elastomers formed from the TPPE precursor composites. Aspects of the disclosure further relate to hydrophilic and hydrophobic porous elastomers that exhibit mechanical toughness, controlled porosity, and chemically tailorable pore functionality.

### BACKGROUND

Porous polymeric materials are used in a large range of applications including, but not limited to particle, molecule, and ion separation membranes applied in dialysis, ultrafiltration and microfiltration processes, rapid ion transport membranes such as those found in battery separators, tissue engineering scaffolds, and wound dressing materials. Many of these polymeric materials achieve their porosity through a range of processing strategies, including irradiation etching, biaxial stretching of semi-crystalline polymer films, vapor-induced or temperature-induced phase inversion processes, all of which produce symmetric or isotropic porosity structures, or immersion precipitation processes that kinetically trap asymmetric or anisotropic structures.

The majority of commercially used processing methods are predicated on producing an appropriate open solid structure and pore space geometry suitable for the intended separation or application, in a polymer substrate or matrix that provides the appropriate mechanical and chemical stability necessary to carry out the application in the desired fluid environment. Often, however, the intrinsic chemical philicity or phobicity of the pore space provided by the polymer substrate is unsuitable for achieving efficient performance, often leading to, for example, insufficient wetting, limited separation efficacy, unintended solute affinities, poor selectivities, and reduced permeabilities. Likewise, in the case of many applications, the unmodified porous polymer substrates are highly sensitive to fouling from inorganic, organic, or biological media in the filtrate.

Membrane manufacturers, for example, often attempt to overcome the lack of chemical specificity in pore surfaces created in the chosen polymer substrate through surface modification processes intended to provide a particularly desired chemical philicity or phobicity, or add a new chemical functionality important to the intended application. Example processes for modifying surfaces include plasma treatments, surface functionalization through chemical etching or oxidation, the addition of polymer coatings or pore surface brush layers through grafting of polymer chains to the surfaces or grafting polymer chains from the surface using largely radical polymerization processes. In general, such processes are plagued by limited efficacy, often associated with the proclivity of polymer surfaces toward rearrangement in the case of plasma treatments and chemical modification with small molecules, and the limited achievable surface coverages and brush densities associated with polymer grafting to or from existing pore spaces.

Beyond possessing the necessary porosity, pore geometry, minimum pore size, pore distribution, and pore surface functionality, the porous polymer substrate used must also carry the mechanical burden and chemical resistance required by the end use application. That is, the high porosity, open polymer structures created must be capable of sustaining repetitive stress loading without fatigue while suppressing susceptibility to fracture and failure are needed to ensure ideal performance. Effective integration of an intrinsic bulk toughness, mechanical durability and ability to absorb stresses elastically becomes critical, such that developing stress concentrations during use do not lead to catastrophic failure and loss of membrane or material function.

Polymer composites are a class materials involving the mixing of more than one immiscible polymer to form a single material. Because the constituent polymers are immiscible and therefore thermodynamically unable to mix on the molecular scale, mechanical, thermal, or solvent assisted mixing is used to produce a microstructure maximizing the interfacial area of contact among the individual polymer domains with the hope of imparting the unique chemical, physical, or mechanical attributes of the constituent polymers to the resulting composite.

This disclosure provides a unique thermoplastic porous elastomer precursor composite material and a method of using the composite to form mechanically durable, chemically resistant, and tough porous elastomer materials in which the pore surface philicity, phobicity, or chemical functionality can be deliberately integrated into the porous polymer substrate prior to the generation of the porosity itself.

### BRIEF DESCRIPTION OF THE DRAWINGS

Embodiments of the present inventive concept are illustrated by way of example in which like reference numerals indicate similar elements and in which:

FIG. 1A shows a two-liter anionic polymerization reactor with solvent delivery achieved through an inverted flask and monomer reactant delivered as a chilled liquid.

FIG. 1B shows one gram batch of SO/SBS blended mixture recovered post-manufacture in a thermally processible powder form.

FIG. 2 depicts the 1H NMR characterization data for the synthesized polystyrene, polystyrene-OH (PS—OH, dbw-1142).

FIG. 3 depicts the 1H NMR characterization data for the polystyrene-b-poly(ethylene oxide)-H, (SO—H, wbm-2028).

FIG. 4 depicts the 1H NMR characterization data for the “one-pot” polymerization of Polystyrene-b-poly(ethylene oxide)-b-polystyrene (SOS asw-2066).

FIG. 5 depicts the thermogravimetric analysis data for SOS asw-2066. Degradation occurring between 407.88° C. and 436.84° C.

FIG. 6 depicts the differential scanning calorimetry data for SOS asw-2066. The crystallization and glass transition of PEO is observed at about 70° C. The large presence of PEO covers what would be the glass transition of PS. However, it is possible that the sharp drop observed from 70° C. to 60° C. in the cooling cycle is the glass transition of PS.

FIG. 7 depicts the 1H NMR characterization data for the Polystyrene-bpolybutadiene-b-polystyrene (SBS, Kraton D-1102).

FIG. 8 depicts the thermogravimetric analysis data for SBS D-1102. Degradation occurring between 450.17° C. and 479.58° C.

FIG. 9 depicts the differential scanning calorimetry data for SBS D-1102. The glass transition of PB is observed at about −90° C. Due to the limitations of the instrument, the DSC can only measure to −90° C. Therefore, a large drop is seen right at the end of the cooling cycle.

FIG. 10 depicts one example of a porous elastomer production method using solvent blending.

FIG. 11A, FIG. 11B, FIG. 11C, FIG. 11D depict SEM Images of freeze fractured surfaces of hydrophilic porous elastomers. FIG. 11A depicts a porous elastomer made with 25 weight percent sacrificial SO at ×100 magnification and ×1,000 magnification. FIG. 11B depicts a porous elastomer made with 50 weight percent sacrificial SO at ×100 magnification and ×1,000 magnification. FIG. 11C depicts a porous elastomer made with 50 weight percent sacrificial SO, before and after swelling with H2O to extract the sacrificial SO component imaged at ×10,000 magnification and highlighted to distinguish the SO and SBS polymers. Poly(ethylene oxide) is expected to be crystalline when dry at room temperature. This can be seen as striations on pore surfaces in the SEM images. This is preliminary visual evidence that the sacrificial SO network leaves a molecularly integrated brush layer on the pore surfaces when removed. FIG. 11D depicts a porous elastomer made with 50 weight percent sacrificial SO at ×10,000 magnification, overlayed with a drawing to highlight the SBS rubber network and a hypothesized, interfacially anchored SO brush layer coating. It's hypothesized that by taking advantage of the micro-phase separation of ABA block copolymers found in thermoplastic elastomers (TPEs), separate TPE materials can be joined together. Two TPEs can be joined together through a shared vitreous component at their interface which molecularly integrates the two TPEs on the micrometer length scale. When placed in water, the untethered SO network is removed except for a SO brush layer which is molecularly integrated into the rubber surface.

FIG. 12 depicts the hydrophilic porous elastomer interface, figures listed left to right: 1 μm scale bar—component blend domains in a SO/SBS blend, 100 nm scale bar—block copolymer morphologies within component domains, 10 nm scale bar—microphase separation of block copolymer blocks, a with hypothesized demonstration of a shared vitreous polystyrene domain compatibilizing the components at their interface, removal of the sacrificial SO domain leaving porous SBS elastomer with an anchored hydrophilic SO brush layer.

FIG. 13 depicts SAXS measurements of neat SO diblock and SBS elastomer taken at 120° C. in situ, inside the Advanced Photon Source Synchrotron, after being annealed at 120° C. for 1 hour. Neat SO diblock exhibits a body-centered cubic phase separation morphology and neat SBS elastomer exhibits a hexagonally packed cylinder morphology.

FIG. 14 is a visual demonstration of the elasticity displayed by a 25 weight % SO network hydrophilic porous elastomer. This series of five photos show consecutive twisting and elastic recovery of a <1 mm thick coupon of hydrophilic porous elastomer.

FIG. 15A shows tensile extension at 2% strain per second to 40% strain comparing neat SBS rubber to two porous elastomer samples with varying pore sizes.

FIG. 15B shows cyclic tensile loading at 2% strain per second and unloading to 100% strain for 10 consecutive cycles comparing neat SBS rubber to the 25% SO network porous elastomer. The porous elastomer shows similar elastic and plastic behavior compared to non-porous, hydrophobic SBS.

FIG. 16A and FIG. 16B show ¹H NMR spectra of the SBS/SO mixture before and after SO extraction. FIG. 16A provides the spectrum with the SO network intact, before extraction, while FIG. 16B and shows the spectrum of the porous elastomer with the SO network removed, following extraction. The decreased ratio of the butadiene (B) protons relative to the ethylene oxide (EO) protons (from 1.6:1—EO:B to 0.15:1—EO:B), confirms 90% removal of the SO component, but the continued presence of the EO peak confirms there is still SO component in the material, supporting the hypothesis of a PEO brush layer on pore surfaces.

FIG. 17 shows x-ray photoelectron spectroscopy C 1s spectra of the porous elastomer and its components. The presence of the ether peak in the porous elastomer spectrum indicates PEO from the SO component is present at the surface of the porous elastomer, supporting the hypothesis that a PEO brush layer is molecularly integrated into the surface of the porous SBS.

FIG. 18A, FIG. 18B, FIG. 18C, FIG. 18D depict a visual hydrophilicity swelling test with blue die. FIG. 18A and FIG. 18B show the porous elastomer before and after being placed in water with blue dye. The blue coloration diffusing into the porous elastomer suggests hydrophilic behavior. FIG. 18C and FIG. 18D show the unmodified control SBS neat, before and after being placed in water with blue dye. The lack of a color change suggests that the unmodified SBS does not stain or absorb the water.

The drawing figures do not limit the present disclosure to the specific embodiments disclosed and described herein. The drawings are not necessarily to scale, emphasis instead being placed on clearly illustrating principles of certain embodiments of the present disclosure.

### SUMMARY

Other features and iterations of the disclosure are described in more detail below.

Disclosed herein is a porous elastomer comprising an elastomeric matrix with one or more pores and a surface coating on the surface of the pores. The elastomeric matrix comprises at least one styrenic block copolymer and at least one styrenic thermoplastic elastomer. The surface coating comprises at least one styrenic block copolymer. In some embodiments, the styrenic block copolymer and the styrenic thermoplastic elastomer each independently comprise at least one non-hydrogenated or hydrogenated styrene block.

In some embodiments, the surface coating is an integrated polymer brush layer. In some embodiments, the integrated polymer brush layer is hydrophilic. In other embodiments, the integrated polymer brush layer is hydrophobic. In some embodiments, one or more accessible functional groups are accessible to the integrated polymer brush layer for additional pore functionality.

In some embodiments, the at least one styrenic thermoplastic elastomer is chemically crosslinked.

In some embodiments, the elastomer matrix has a porosity of between about 15 to about 85%. In other embodiments, the porosity is between about 30 to about 70%.

In some embodiments, the pores comprises a pore size of about 0.1 microns to about 50 microns. In other embodiments, the pores comprises a pore size of about 0.1 microns to about 20 microns. In other embodiments, the pores comprises a pore size of about 0.1 microns to about 10 microns.

In some embodiments, the porous elastomer is resistant to organic fouling, inorganic fouling, biological fouling, or any combination thereof.

In some embodiments, the porous elastomer comprises a bulk modulus averaged over the initial 10% strain of about 0.1 MPa to about 25 MPa.

In some embodiments, the porous elastomer is resistant to fatigue, wear, fracture, degradation, or any combination thereof.

In some embodiments, the styrenic block copolymer comprises at least one block copolymer comprising at least one non-styrenic hydrophilic block and the styrenic thermoplastic elastomer comprises at least one block copolymer comprising at least one non-styrenic hydrophilic block.

In some embodiments, the styrenic block copolymer comprises at least one block copolymer comprising at least one non-styrenic hydrophilic block and the styrenic thermoplastic elastomers comprises at least one block copolymer comprising at least one non-styrenic hydrophobic block.

In some embodiments, the styrenic block copolymer comprises at least one block copolymer comprising at least one non-styrenic hydrophobic block and the styrenic thermoplastic elastomer comprises at least one block copolymer comprising at least one non-styrenic hydrophilic block.

In some embodiments, the styrenic block copolymer comprises at least one block copolymer comprising at least one non-styrenic hydrophobic block and the styrenic thermoplastic elastomer comprises at least one block copolymer comprising at least one non-styrenic hydrophobic block.

In some embodiments, each of the styrenic block copolymer and/or the styrenic thermoplastic elastomer comprises diblock copolymers, triblock copolymers, tetrablock copolymers, pentablock copolymers, or any combination thereof.

In some embodiments, the least one hydrophilic block comprises at least one polyalkylene oxide block.

In some embodiments, the at least one polyalkylene oxide block comprises a polyethylene oxide block.

In some embodiments, the at least one hydrophobic block comprises at least one hydrophobic non-glassy block.

In some embodiments, the at least one hydrophobic non-glassy block comprises a polydiene, a substituted polydiene, a hydrogenated polydiene, a substituted hydrogenated polydiene, a polysiloxane, a substituted polysiloxane, or any combination thereof.

In some embodiments, the ratio of the styrenic block copolymer to the styrenic thermoplastic elastomer is 1:4 to 4:1. In other embodiments, the ratio of the styrenic block copolymer to the styrenic thermoplastic elastomer is 1:2 to 2:1.

In some embodiments, the styrenic block copolymer comprising at least one non-styrenic hydrophilic block comprises a polystyrene-poly(ethylene oxide) diblock copolymer (SO).

In some embodiments, the styrenic block copolymer comprising at least one non-styrenic hydrophobic block comprises at least one block copolymer selected from a polystyrene-polybutadiene diblock copolymer (SB), a substituted SB diblock copolymer, a polystyrene-polyisoprene diblock copolymer (SI), a substituted SI diblock copolymer, a polystyrene-poly(ethylene butylene) diblock copolymer (SEB), a substituted SEB diblock copolymer, a polycyclohexylethylene-poly(ethylene butylene) diblock copolymer (PEB), a substituted PEB diblock copolymer, a polystyrene-polysiloxane diblock copolymer (SD), a substituted SD diblock copolymer, or any combination thereof.

In some embodiments, the styrenic thermoplastic elastomer comprising at least one non-styrenic hydrophilic block comprises a polystyrene-polyethylene oxide-polystyrene triblock copolymer (SOS).

In some embodiments, the styrenic thermoplastic elastomer comprising at least one non-styrenic hydrophobic block comprises at least one styrenic thermoplastic elastomer selected from a polystyrene-polybutadiene-polystyrene triblock copolymer (SBS), a substituted SBS triblock copolymer, a polystyrene-polyisoprene-polystyrene triblock copolymer (SIS), a substituted SIS triblock copolymer, a polystyrene-poly(ethylene butylene)-polystyrene triblock copolymer (SEBS), a substituted SEBS triblock copolymer, a polycyclohexylethylene-poly(ethylene butylene)-polycyclohexylethylene triblock copolymer (PEBP), a substituted PEBP triblock copolymer, a polystyrene-polysiloxane-polystyrene triblock copolymer (SDS), a substituted SDS triblock copolymer, or any combination thereof.

In some embodiments, the at least one styrenic block copolymer and at least one styrenic thermoplastic elastomer comprise SO and SBS.

In some embodiments, the at least one styrenic block copolymer and at least one styrenic thermoplastic elastomer comprise SO and SEBS.

In some embodiments, the at least one styrenic block copolymer and at least one styrenic thermoplastic elastomer comprise SO and SDS.

In some embodiments, the at least one styrenic block copolymer and at least one styrenic thermoplastic elastomer comprise SD and SOS.

In some embodiments, the ratio of the SO styrenic diblock copolymer to the styrenic thermoplastic elastomer is 1:4 to 4:1.

In some embodiments, the ratio of the SD styrenic diblock copolymer to the styrenic thermoplastic elastomer is 1:4 to 4:1.

The present disclosure further relates to a method for preparing a porous elastomer comprising (a) providing a thermoplastic porous elastomer (TPPE) precursor composite dry blend wherein the TPPE precursor composite dry blend comprises the at least one styrenic block copolymer and at least one styrenic thermoplastic elastomer of any one of claims 1-35, and (b) washing the TPPE precursor composite dry blend in a liquid to remove unbound styrenic block copolymer and form the porous elastomer. In some embodiments, the washing step (b) comprises removing and replacing the liquid medium at least twice. In some embodiments, the method comprises (c) drying the porous elastomer to remove any residual wash liquid after step (b). In some embodiments, washing the TPPE precursor step (b) includes placing the precursor composite in a liquid medium at a specified temperature range. In some embodiments, the porous elastomer obtained by the disclosed methods retains a porous structure after the step (c).

In some embodiments, the providing step (a) includes (i) contacting the at least one styrenic block copolymer and at least one styrenic thermoplastic elastomer of any one of claims 1-35 to form a TPPE precursor composite dry blend, (ii) heating the TPPE precursor composite dry blend to form a TPPE precursor composite melt, and (ii) cooling the TPPE precursor composite melt to attain ambient temperature to form an TPPE precursor composite of the at least one styrenic block copolymer and at least one styrenic thermoplastic elastomer.

In some embodiments, the at least one styrenic thermoplastic elastomer in the TPPE precursor composite or the TPPE precursor composite is chemically crosslinked.

In some embodiments, the specified temperature range for the washing step (b) is from about −10° C. to about 160° C.

In some embodiments, the liquid medium is an aqueous medium comprising at least one aqueous solvent, an aqueous electrolyte, or combinations thereof.

In some embodiments, the liquid medium comprises one or more non-aqueous solvents, non-aqueous liquid electrolytes, or a combination thereof.

In some embodiments, the TPPE precursor composite dry blend is formed by dissolving the at least one styrenic block copolymer and at least one styrenic thermoplastic elastomer in a solvent and removing the solvent.

In some embodiments, the TPPE precursor composite dry blend is formed by heating the at least one styrenic block copolymer and at least one styrenic thermoplastic elastomer between about 80° C. and 320° C.

In some embodiments, the TPPE precursor composite dry blend is formed by heating the at least one styrenic block copolymer and at least one styrenic thermoplastic elastomer between about 5 minutes and 60 minutes.

In some embodiments, the TPPE precursor composite dry blend is heated in the presence of applied pressure between about 1000 lbf and 25000 lbf.

In some embodiments, step (b), heating the TPPE precursor composite dry blend, further comprises mechanical mixing, compounding, or extrusion.

In some embodiments, step (b), heating the TPPE precursor composite dry blend, comprises mechanical mixing with at least one screw with mixing speed between about 50 rpm and 250 rpm.

In some embodiments, the TPPE precursor composite dry blend has a microstructure characterized by block copolymer or thermoplastic elastomer domains of sizes of about 0.1 microns to about 10 microns, about 0.1 microns to about 20 microns, or about 0.1 microns to about 50 microns.

The present disclosure also relates to a liquid phase separation membrane comprising a porous elastomer described above. In some embodiments, the membrane permits the selective separation of particles, proteins, protein assemblies, viruses, molecules, or ions from a liquid medium or filtrate.

The present disclosure also relates to a wound dressing comprising the porous elastomer described above.

The present disclosure also relates to A tissue engineering scaffold comprising the porous elastomer described above.

The present disclosure also relates to a surface coating applied to another polymer, glass, metal, ceramic, composite or any combination thereof comprising the porous elastomer described above.

The present disclosure further relates to a supported liquid membrane comprising the porous elastomer described above. In some embodiments, the porous elastomer is saturated with a second liquid medium. In other embodiments, the second liquid medium comprises one or more room-temperature ionic liquids (RTIL) selected from the group consisting of 1-ethyl-3-methyl imidazolium bis(trifluoromethane)sulfonamide ([EMIM][TFSI]), 1-hexyl-3-methyl imidazolium bis(trifluoromethane)sulfonamide ([HMIM][TFSI]), 1-vinyl-3-ethyl-imidazolium bis(trifluoromethane)sulfonamide ([VEIM][TFSI]), 1-allyl-3-methyl-imidazolium bis(trifluoromethane)sulfonamide ([AMIM][TFSI]), 1-hexyl-3-butyl-imidazolium bis(trifluoromethane)sulfonamide ([HBIM][TFSI]), 1-vinyl-3-methylimidazolium bis(trifluoromethane)sulfonamide ([VMIM][TFSI]), 1-hydroxyundecanyl-3-methylimidazolium bis(trifluoromethane)sulfonamide ([(C₁₁OH)MIM][TFSI]), 1-ethyl-3-methylimidazolium tricyanomethanide ([EMIM][TCM]), tetrabutylphosphonium taurinate, ([P4444][Tau]), 1-ethyl-3-methylimidazolium dicyanamide ([EMIM][DCA]), 1-(2,3-dihydroxypropyl)-alkyl imidazolium dicyanamide ([(dhp)MIM][DCA]), 1-(2,3-dihydroxypropyl)-3-alkyl imidazolium tetrafluoroborate ([(dhp)MIM][BF4]), 1-(2,3-dihydroxypropyl)-3-alkyl imidazolium bis(trifluoromethane)sulfonimide ([(dhp)MIM][TFSI]), and 1-(2,3-dihydroxypropyl)-3-alkyl imidazolium hexafluorophosphate ([(dhp)MIM][PF6]).

In some embodiments, the supported liquid membrane is used as a gas phase separation membrane with a CO₂/N₂ selectivity between about 10:1 and about 60:1.

In some embodiments, the supported liquid membrane is used as a battery separator or flexible ionic conductor with an ionic conductivity comparable to the ionic conductivity of the liquid electrolyte.

### DETAILED DESCRIPTION

The present disclosure may be understood by reference to the following detailed description, taken in conjunction with the drawings as described above.

This disclosure provides a thermoplastic elastomer composite material comprised of at least two components, that is formed as an easily processible precursor to a final porous elastomer product. The first required component of the composite is a styrenic block copolymer and the second is a styrenic thermoplastic elastomer (TPE).

In this disclosure, the phase separation behavior is exploited to create a thermoplastic porous elastomer (TPPE) precursor composite by combining a block copolymer with a TPE, each of which share a common styrenic vitreous polymer block. These composites are formed through the addition of thermal energy, mechanical energy, solvents, or any combination of these, to a dry blend of the block copolymer and thermoplastic elastomer, followed by cooling or drying to form a solid precursor composite. By carefully selecting the right processing methods, conditions, and techniques, the formed TPPE precursor composite material is produced with a microstructure characterized by co-continuous block copolymer and TPE macro domains with macro domain sizes in the submicron and micron length scales. Such co-continuous microstructures are critical for maximizing pore continuity while retaining a majority of the strength of the original TPE.

Within this TPPE precursor composite, the styrenic block copolymer serves two critical functions in the disclosure. First, it chosen so that it can be selectively solvated and washed from the composite, generating the desired porosity in the remaining elastomer matrix. However, because the block copolymer shares a common styrenic vitreous polymer block with the elastomer, all block copolymer located at the interfaces with the elastomer matrix remains bound to the elastomer surface during the washing steps. As such, the block copolymer forms a fixed, and maximally dense, polymer brush layer at all pore surfaces exposed after all unbound block copolymer is removed. Thus, the second critical function of the block copolymer is to impart the desired surface philicity, phobicity, or chemical functionality in the form of a durable high density polymer brush layer integrated into all formed pore surfaces within the elastomer.

### I. Definitions

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

As used herein, the terms “about” and “approximately” designate that a value is within a statistically meaningful range. Such a range can be typically within 20%, more typically within 10%, and even more typically within 5% of a given value or range. The allowable variation encompassed by the terms “about” and “approximately” depends on the particular system under study and can be readily appreciated by one of ordinary skill in the art.

When introducing elements of the present disclosure or the preferred embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used herein, “and/or” refers to and encompasses any and all possible combinations of one or more of the associated listed items, as well as the lack of combinations where interpreted in the alternative (“or”).

As used herein, “porous” refers to a surface full of tiny holes or openings. The holes or openings are also referred to as pores.

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise-Indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

As used herein “ambient temperature” or “room temperature” is the temperature of the environment surrounding the process or experimental apparatus.

As used herein, the term “glass” refers to completely vitrified solids as well as to partially crystalline or glassy solids. Generally, a “glass” is a material below its glass transition temperature (T_{g}), as defined by for example differential scanning calorimetry (DSC) or dynamic mechanical analysis (DMA). Use temperatures defined as a range include all temperatures in which the swelling medium remains in the liquid phase. For aqueous media this may have a range including 0-100° C. For room temperature ionic liquids, as described herein, this may have a range from 0-160° C. Typically, the glassy domains may have a glass transition temperature of at least 40° C.

As used herein, the term “monomer” refers to any chemical compound capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized, the polymers formed from such monomers are then termed “block polymers.” Monomers may belong to various chemical classes of molecules including organic, organometallic, or inorganic molecules. The molecular weight of monomers may vary greatly range between about 4 Daltons and 20000 kDaltons. However, especially when monomers comprise repetitive building blocks, monomers may have even higher molecular weights. Monomers may also include additional reactive groups.

### II. Thermoplastic Porous Elastomer Precursor Composites

The present disclosure provides thermoplastic porous elastomer (TPPE) precursor composites. These TPPE precursor composites comprise at least one styrenic block copolymer and at least one styrenic thermoplastic elastomer (TPE).

### (a) Block Copolymers

The present disclosure provides thermoplastic porous elastomer (TPPE) precursor composites comprising block copolymers. Block copolymers may be understood to comprise multiblock (e.g., diblock, triblock, tetrablock, and so on) copolymers.

A block copolymer consists of two or more strands (“blocks” or “polymer blocks”) of different polymers chemically attached to each other. Properties of block copolymers herein can depend on copolymer sequence distribution, chemical nature of the blocks, average molecular weight, molecular weight distribution of the blocks and the copolymer, and any combination thereof.

A block copolymer is a polymer that consists of multiple different types of polymer chains that are covalently attached to each other. The monomers comprising a block copolymer are referred to as “A block”, “B block”, and a like. Accordingly, a diblock copolymer comprised of A and B blocks can be referred to as an AB block copolymer whereas triblock copolymer comprised of A, B, and C blocks can be referred to as an ABC block copolymer, a tetrablock copolymer comprised of A, B, C, and D blocks can be referred to as an ABCD block copolymer, and so on. AB block copolymer morphology is governed by three variables, volume fraction of one block (f_{A}) and the Flory-Huggins interaction parameter between the blocks (χ_{AB}), and the overall polymer degree of polymerization or molecular weight. Adding just one block adds more variables which govern phase separation; ABC block copolymers are governed by the volume fractions of two blocks (which necessarily determine the third) (f_{A}, f_{B}) and the interaction parameters between all three blocks (χ_{AB}, χ_{AC}, χ_{BC}), and the overall polymer degree of polymerization or molecular weight. In contrast to AB block copolymers, the added block in ABC block polymers allows for formation of additional morphologies and microstructures.

The present disclosure provides TPPE precursor composites comprising diblock copolymers. Diblock copolymers herein may contain at least two polymer blocks according to Formula (I):

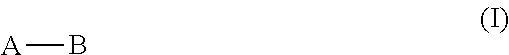

wherein A and B are unique polymer blocks. A detailed description of examples of diblock copolymers can be found in U.S. Pat. Nos. 10,428,185 and 10,532,130, the contents of which are hereby incorporated by reference in their entirety.

The present disclosure provides TPPE precursor composites comprising triblock copolymers. Triblock copolymers described herein may contain at least three polymer blocks according to Formula (II):

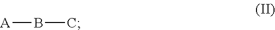

wherein A, B, and C are polymer blocks. In various embodiments, the at least one of A, B, or C is a different polymer block than the other two. In other yet other some embodiments, the order of the polymer blocks is random. In still other embodiments, the order of the polymer blocks is specific.

The present disclosure provides TPPE precursor composites comprising tetrablock copolymers. tetrablock copolymers described herein may contain at least four polymer blocks according to Formula (III):

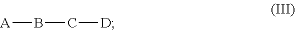

wherein A, B, C, and D are polymer blocks. In various embodiments, the at least one of A, B, C, or D is a different polymer block than the other three. In other yet other some embodiments, the order of the polymer blocks is random. In still other embodiments, the order of the polymer blocks is specific.

The present disclosure provides TPPE precursor composites comprising pentablock copolymers. Pentablock copolymers described herein may contain at least five polymer blocks according to Formula (IV):

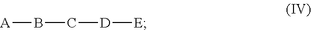

wherein A, B, C, and D and E are polymer blocks. In various embodiments, the at least one of A, B, C, D or E is a different polymer block than the other four. In yet other embodiments, the order of the polymer blocks is random. In still other embodiments, the order of the polymer blocks is specific.

The block copolymers may comprise polymer blocks ranging in number average molecular weight (Mn) and/or volume fraction of the final block copolymer. Methods of measuring Mn and/or volume fraction are known in the art and are suitable for use herein. Mn may be determined by proton nuclear magnetic resonance (¹H-NMR). Volume fractions (f) may be calculated from monomer weight and polymer densities at a desired temperature. In general, the desired temperature suitable for measuring volume fractions may be about 120° C. to about 150° C.

### (b) Thermoplastic Elastomers

The present disclosure provides TPPE precursor composites comprising thermoplastic elastomers. Thermoplastic elastomers (TPE) described herein represent a special class of multiblock copolymers, in which two polymer blocks are selected to be glassy or vitreous at room temperature and are joined end to end by at least one non-glassy block. During microphase separation, the glassy blocks form a microstructure that creates a network of physical crosslinks in the TPE. Such crosslinks, in combination with the non-glassy, rubbery block, provide the elastomeric properties of the material. By way of a non-limiting example, the TPE may comprise a triblock copolymer comprising at least three polymer blocks according to Formula (V):

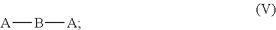

wherein A, B, and A are polymer blocks. In various embodiments, the TPE may comprise A blocks that are glassy polymers at room temperature, and the B blocks that are non-glassy polymers at room temperature. In yet other embodiments, the TPE may comprise diblock copolymers, triblock copolymers, tetrablock copolymers, multiblock copolymers or any combination thereof. In yet other embodiments, the TPE may comprise just a triblock copolymer or it may comprise both a diblock copolymer and a triblock copolymer.

### (c) Styrenic Block Copolymers and Styrenic Thermoplastic Elastomers

Styrenic block copolymers described herein comprise block copolymers comprising a styrenic block or hydrogenated form of a styrenic block. By way of a non-limiting example, a hydrogenated styrenic block copolymer could contain the hydrogenated form polycyclohexylethylene. The non-styrenic blocks of the styrenic or hydrogenated styrenic block copolymer can be either hydrophobic or hydrophilic. A styrenic block copolymer can comprise diblock copolymers, triblock copolymers, tetrablock copolymers, multiblock copolymers or any combination thereof. A styrenic block copolymer may contain homopolymers of each block. By way of a non-limiting example, a styrenic block copolymer of the present disclosure may comprise just a diblock copolymer or it may comprise both a diblock copolymer and homopolymer.

Styrenic TPEs described herein comprise styrenic block copolymers or the hydrogenated forms of those styrenic block copolymers. By way of a non-limiting example, a hydrogenated styrenic TPE could contain the hydrogenated form polycyclohexylethylene. The non-styrenic blocks of the styrenic or hydrogenated styrenic TPE can be either hydrophobic or hydrophilic. A styrenic TPE can comprise triblock copolymers, tetrablock copolymers, multiblock copolymers or any combination thereof. A styrenic TPE may contain diblock copolymers or homopolymers. By way of a non-limiting example, a styrenic TPE of the present disclosure may comprise just a triblock copolymer or it may comprise both a diblock copolymer and a triblock copolymer.

Styrenic block copolymers and styrenic TPEs described herein may be selected to impart certain properties and/or characteristics on the TPPE precursor composites.

The at least one styrenic block copolymer or at least one styrenic TPE may comprise at least one block copolymer comprising at least one non-styrenic hydrophilic block. Generally, the hydrophilic block comprises at least one polyalkylene oxide block. Non-limiting examples of polyalkylene oxides for use in the polyalkylene oxide block can include polyethylene oxide, polypropylene oxide, polybutylene oxide and the like.

The at least one hydrophilic block used in TPPE precursor composite compositions herein may comprise at least one polyalkylene oxide block. In some embodiments, the polyalkylene oxide block herein may be polyethylene oxide (PEO) block. Generally, the PEO block may have an average molecular weight of 20 kDa to 800 kDa. In various embodiments, the PEO block may have an average molecular weight from about 20 kDa to about 25 kDa, about 25 kDa to about 30 kDa, about 30 kDa to about 35 kDa, from about 35 kDa to about 40 kDa from about 40 kDa to about 45 kDa, from about 45 kDa to about 50 kDa, from about 50 kDa to about 55 kDa, from about 55 kDa to about 60 kDa, from about 60 kDa to about 65 kDa, from about 65 kDa to about 70 kDa, from about 70 kDa to about 75 kDa, from about 75 kDa to about 80 kDa, from about 80 kDa to about 85 kDa, from about 85 kDa to about 90 kDa, from about 90 kDa to about 95 kDa, from about 95 kDa to about 100 kDa, from about 100 kDa to about 105 kDa, from about 105 kDa to about 110 kDa, from about 110 kDa to about 115 kDa, from about 115 kDa to about 120 kDa, from about 120 kDa to about 125 kDa, from about 125 kDa to about 130 kDa, from about 130 kDa to about 135 kDa, from about 135 kDa to about 140 kDa, from about 140 kDa to about 145 kDa, from about 145 kDa to about 150 kDa, from about 150 kDa to about 155 kDa, from about 155 kDa to about 160 kDa, from about 160 kDa to about 170 kDa, from about 170 kDa to about 180 kDa, from about 180 kDa to about 190 kDa, from about 190 kDa to about 200 kDa, from about 200 kDa to about 250 kDa, from about 250 kDa to about 300 kDa, from about 300 kDa to about 350 kDa, from about 350 kDa to about 400 kDa, from about 400 kDa to about 450 kDa, from about 450 kDa to about 500 kDa, from about 500 kDa to about 550 kDa, from about 550 kDa to about 600 kDa, from about 600 kDa to about 650 kDa, from about 650 kDa to about 700 kDa, or from about 750 kDa to about 800 kDa. In one embodiment, the PEO block may have an average molecular weight of greater than about 100 kDa.

The at least one styrenic block copolymer and/or the at least one styrenic TPE used in compositions herein may comprise at least one non-styrenic hydrophobic block. In general, the hydrophobic block comprises at least one hydrophobic non-glassy block. Non-limiting examples of hydrophobic non-glassy blocks comprise a polydiene, a hydrogenated polydiene, a polysiloxane, or any combinations thereof. In some embodiments the hydrophobic non-glassy blocks may comprise a substituted block, for example a substituted polydiene or a substituted polysiloxane.

The at least one styrenic block copolymer and/or at least one styrenic TPE used in compositions herein may comprise at least one polydiene block, or a hydrogenated form of a polydiene block. Polydienes are amorphous polymers having a glass transition temperature below room temperature, usually ranging between 170 and 250 K (−100° C. and −25° C.). Suitable non-limiting examples of polydienes can include polybutadiene (PB), polychloroprene, polyisoprene (PI), or hydrogenated forms of polydienes such as poly(ethylene butylene) (PEP), poly(ethyl ethylene (PEE) and the like.

The at least one hydrophobic block used in TPPE precursor composite compositions herein may comprise at least one polydiene block. In general, polydiene block may have an average molecular weight of 20 kDa to 800 kDa. In general, the polydiene block may have an average molecular weight from about 20 kDa to about 25 kDa, about 25 kDa to about 30 kDa, about 30 kDa to about 35 kDa, from about 35 kDa to about 40 kDa from about 40 kDa to about 45 kDa, from about 45 kDa to about 50 kDa, from about 50 kDa to about 55 kDa, from about 55 kDa to about 60 kDa, from about 60 kDa to about 65 kDa, from about 65 kDa to about 70 kDa, from about 70 kDa to about 75 kDa, from about 75 kDa to about 80 kDa, from about 80 kDa to about 85 kDa, from about 85 kDa to about 90 kDa, from about 90 kDa to about 95 kDa, from about 95 kDa to about 100 kDa, from about 100 kDa to about 105 kDa, from about 105 kDa to about 110 kDa, from about 110 kDa to about 115 kDa, from about 115 kDa to about 120 kDa, from about 120 kDa to about 125 kDa, from about 125 kDa to about 130 kDa, from about 130 kDa to about 135 kDa, from about 135 kDa to about 140 kDa, from about 140 kDa to about 145 kDa, from about 145 kDa to about 150 kDa, from about 150 kDa to about 155 kDa, from about 155 kDa to about 160 kDa, from about 160 kDa to about 170 kDa, from about 170 kDa to about 180 kDa, from about 180 kDa to about 190 kDa, from about 190 kDa to about 200 kDa, from about 200 kDa to about 250 kDa, from about 250 kDa to about 300 kDa, from about 300 kDa to about 350 kDa, from about 350 kDa to about 400 kDa, from about 400 kDa to about 450 kDa, from about 450 kDa to about 500 kDa, from about 500 kDa to about 550 kDa, from about 550 kDa to about 600 kDa, from about 600 kDa to about 650 kDa, from about 650 kDa to about 700 kDa, or from about 750 kDa to about 800 kDa. In one embodiment, the polydiene block may have an average molecular weight of greater than about 100 kDa.

The polydiene block may be completely or partially hydrogenated. A hydrogenated polydiene may yield ethyl ethylene or ethyl butylene moieties. For example, the polydiene domain of the block copolymer may be based on the hydrogenated forms of diene monomers, such as ethyl ethylene or ethyl butylene. In various embodiments, hydrogenation of a polydiene block may transform polybutadiene into polyethylethylene (PEE) or poly(ethylene butylene) (PEB), or polyisoprene into poly(ethylene alt propylene) (PEP).

In various embodiments, the hydrogenation of a polydiene herein may occur under increased partial pressure of hydrogen, with a catalyst, or without a catalyst. Suitable non-limiting catalysts include palladium, platinum, rhodium, ruthenium, nickel, or other transition metals. A catalyst may further comprise a support matrix, such as calcium carbonate (CaCO₃), carbon, porous silica, and a like. Suitable non-limiting examples of hydrogenation catalysts on supports include, but are not limited to, palladium on carbon, palladium on calcium carbonate, and platinum on porous silica.

The at least one hydrophobic block used in TPPE precursor composite compositions herein may comprise at least one polysiloxane block. Generally, the polysiloxane block may have an average molecular weight of 20 kDa to 800 kDa. In various embodiments, the polysiloxane block may have an average molecular weight from about 20 kDa to about 25 kDa, about 25 kDa to about 30 kDa, about 30 kDa to about 35 kDa, from about 35 kDa to about 40 kDa from about 40 kDa to about 45 kDa, from about 45 kDa to about 50 kDa, from about 50 kDa to about 55 kDa, from about 55 kDa to about 60 kDa, from about 60 kDa to about 65 kDa, from about 65 kDa to about 70 kDa, from about 70 kDa to about 75 kDa, from about 75 kDa to about 80 kDa, from about 80 kDa to about 85 kDa, from about 85 kDa to about 90 kDa, from about 90 kDa to about 95 kDa, from about 95 kDa to about 100 kDa, from about 100 kDa to about 105 kDa, from about 105 kDa to about 110 kDa, from about 110 kDa to about 115 kDa, from about 115 kDa to about 120 kDa, from about 120 kDa to about 125 kDa, from about 125 kDa to about 130 kDa, from about 130 kDa to about 135 kDa, from about 135 kDa to about 140 kDa, from about 140 kDa to about 145 kDa, from about 145 kDa to about 150 kDa, from about 150 kDa to about 155 kDa, from about 155 kDa to about 160 kDa, from about 160 kDa to about 170 kDa, from about 170 kDa to about 180 kDa, from about 180 kDa to about 190 kDa, from about 190 kDa to about 200 kDa, from about 200 kDa to about 250 kDa, from about 250 kDa to about 300 kDa, from about 300 kDa to about 350 kDa, from about 350 kDa to about 400 kDa, from about 400 kDa to about 450 kDa, from about 450 kDa to about 500 kDa, from about 500 kDa to about 550 kDa, from about 550 kDa to about 600 kDa, from about 600 kDa to about 650 kDa, from about 650 kDa to about 700 kDa, or from about 750 kDa to about 800 kDa. In one embodiment, the polysiloxane block may have an average molecular weight of greater than about 100 kDa

The TPPE precursor composite compositions herein may comprise at least one polystyrene block (PS). The PS may be used in block copolymers or TPES with hydrophobic and/or hydrophilic blocks. In general, the PS may have an average molecular weight of 3 kDa to 800 kDa. In various embodiments, PS may have an average molecular weight of about 3 kDa to about 5 kDa, about 5 kDa to about 10 kDa, about 10 kDa to about 15 kDa, about 15 kDa to about 20 kDa, about 20 kDa to about 25 kDa, about 25 kDa to about 30 kDa, about 30 kDa to about 35 kDa, from about 35 kDa to about 40 kDa from about 40 kDa to about 45 kDa, from about 45 kDa to about 50 kDa, from about 50 kDa to about 55 kDa, from about 55 kDa to about 60 kDa, from about 60 kDa to about 65 kDa, from about 65 kDa to about 70 kDa, from about 70 kDa to about 75 kDa, from about 75 kDa to about 80 kDa, from about 80 kDa to about 85 kDa, from about 85 kDa to about 90 kDa, from about 90 kDa to about 95 kDa, from about 95 kDa to about 100 kDa, from about 100 kDa to about 105 kDa, from about 105 kDa to about 110 kDa, from about 110 kDa to about 115 kDa, from about 115 kDa to about 120 kDa, from about 120 kDa to about 125 kDa, from about 125 kDa to about 130 kDa, from about 130 kDa to about 135 kDa, from about 135 kDa to about 140 kDa, from about 140 kDa to about 145 kDa, from about 145 kDa to about 150 kDa, from about 150 kDa to about 155 kDa, from about 155 kDa to about 160 kDa, from about 160 kDa to about 170 kDa, from about 170 kDa to about 180 kDa, from about 180 kDa to about 190 kDa, from about 190 kDa to about 200 kDa, from about 200 kDa to about 250 kDa, from about 250 kDa to about 300 kDa, from about 300 kDa to about 350 kDa, from about 350 kDa to about 400 kDa, from about 400 kDa to about 450 kDa, from about 450 kDa to about 500 kDa, from about 500 kDa to about 550 kDa, from about 550 kDa to about 600 kDa, from about 600 kDa to about 650 kDa, from about 650 kDa to about 700 kDa, or from about 750 kDa to about 800 kDa. In one embodiment, the PS may have an average molecular weight of greater than about 3 kDa. In another embodiments, the PS may have an average molecular weight of less than 800 kDa.

The PS block may be completely or partially hydrogenated. A hydrogenated PS may yield cyclohexyl, cyclohexenyl, and/or cyclohexadienyl moieties. For example, the PS domain of the block copolymer or the TPE may be based on the hydrogenated forms of styrenic monomers, such as vinyl cyclohexylethylene. In various embodiments, the hydrogenation of a PS herein may occur under increased partial pressure of hydrogen, with a catalyst, or without a catalyst. Suitable non-limiting catalysts include palladium, platinum, rhodium, ruthenium, nickel, or other transition metals. A catalyst may further comprise a support matrix, such as calcium carbonate (CaCO₃), carbon, porous silica, and a like. Suitable non-limiting examples of hydrogenation catalysts on supports include, but are not limited to, palladium on carbon, palladium on calcium carbonate, and platinum on porous silica.

The block copolymers herein may comprise a polystyrene block or a hydrogenated polystyrene block wherein the volume fraction ranges from about 0.005 f to about 0.6 f. In various embodiments, block copolymers herein may comprise a polystyrene block (PS) or hydrogenated polystyrene block wherein the volume fraction may be about 0.005, about 0.01, about 0.02, about 0.03, about 0.04, about 0.05, about 0.06, about 0.07, about 0.08, about 0.09, about 0.1, about 0.2, about 0.3, about 0.4, about 0.5, about 0.6 f. In one embodiment, the block copolymers herein may comprise a polystyrene block or hydrogenated polystyrene block wherein the volume fraction may be about 0.005 to about 0.5 f.

Generally, the block copolymers herein may comprise a polydiene block or a hydrogenated polydiene block wherein the volume fraction ranges from about 0.1 f to about 0.9 f. In various embodiments, block copolymers herein may comprise a polydiene block wherein the volume fraction may be about 0.1, about 0.2, about 0.3, about 0.4, about 0.5, about 0.6, about 0.7, about 0.8, or about 0.9 f. In one embodiment, the block copolymers herein may comprise a polydiene block wherein the volume fraction may be about 0.6 to about 0.8 f.

Generally, the block copolymers herein may comprise a polysiloxane block wherein the volume fraction ranges from about 0.1 f to about 0.99 f. In various embodiments, block copolymers herein may comprise a polydiene block wherein the volume fraction may be about 0.1, about 0.2, about 0.3, about 0.4, about 0.5, about 0.6, about 0.7, about 0.8, about 0.9 or about 0.99 f. In one embodiment, the block copolymers herein may comprise a polydiene block wherein the volume fraction may be about 0.8 to about 0.99 f.

Generally, the block copolymers herein may comprise a PEO block wherein the volume fraction ranges from about 0.1 f to about 0.99 f. In various embodiments, the block copolymers herein may comprise a PEO block wherein the volume fraction may be about 0.1, about 0.2, about 0.3, about 0.4, about 0.5, about 0.6, about 0.7, about 0.8, about 0.9, or about 0.99 f. In one embodiment, the block copolymers herein may comprise a PEO block wherein the volume fraction may be about 0.8 to about 0.99 f.

In general, the block copolymers herein may comprise a polybutadiene block or a hydrogenated polybutadiene block wherein the volume fraction ranges from about 0.1 f to about 0.9 f. In various embodiments, the styrenic TPEs herein may comprise a polybutadiene block or hydrogenated polybutadiene block wherein the volume fraction may be about 0.1, about 0.2, about 0.3, about 0.4, about 0.5, about 0.6, about 0.7, about 0.8, or about 0.9 f.

In general, the block copolymers herein may comprise a polyisoprene block or a hydrogenated polyisoprene block wherein the volume fraction ranges from about 0.1 f to about 0.9 f. In various embodiments, the styrenic TPEs herein may comprise a polyisoprene block or hydrogenated polyisoprene block wherein the volume fraction may be about 0.1, about 0.2, about 0.3, about 0.4, about 0.5, about 0.6, about 0.7, about 0.8, or about 0.9 f.

In general, the block copolymers herein may comprise a polydimethylsiloxane block wherein the volume fraction ranges from about 0.1 f to about 0.9 f. In various embodiments, the styrenic TPEs herein may comprise a polydimethyl siloxane block wherein the volume fraction may be about 0.1, about 0.2, about 0.3, about 0.4, about 0.5, about 0.6, about 0.7, about 0.8, or about 0.9 f.

In an embodiment, the at least one styrenic block copolymer comprising at least one block copolymer comprising at least one hydrophilic block is a polystyrene-polyethylene oxide diblock copolymer (SO or PS-PEO) and the at least one styrenic TPE comprising at least one block copolymer comprising at least one hydrophobic block is a polystyrene-butadiene-polystyrene triblock copolymer (SBS or PS-PB-PS).

In an embodiment, the at least one styrenic block copolymer comprising at least one block copolymer comprising at least one hydrophilic block is a polystyrene-polyethylene oxide diblock copolymer (SO or PS-PEO) and the at least one styrenic TPE comprising at least one block copolymer comprising at least one hydrophobic block is a polystyrene-poly(ethylene butylene)-polystyrene triblock copolymer (SEBS or PS-PEB-PS).

In an embodiment, the at least one styrenic block copolymer comprising at least one block copolymer comprising at least one hydrophilic block is a polystyrene-polyethylene oxide diblock copolymer (SO or PS-PEO) and the at least one styrenic TPE comprising at least one block copolymer comprising at least one hydrophobic block is a polystyrene-polyisoprene-polystyrene triblock copolymer (SIS or PS-PI-PS).

In an embodiment, the at least one styrenic block copolymer comprising at least one block copolymer comprising at least one hydrophilic block is a polystyrene-polyethylene oxide diblock copolymer (SO or PS-PEO) and the at least one styrenic TPE comprising at least one block copolymer comprising at least one hydrophobic block is a polystyrene-polydimethylsiloxane-polystyrene triblock copolymer (SDS or PS-PDMS-PS).

In an embodiment, the at least one styrenic block copolymer comprising at least one block copolymer comprising at least one hydrophobic block is a polystyrene-polydimethylsiloxane diblock copolymer (SD or PS-PDMS) and the at least one styrenic TPE comprising at least one block copolymer comprising at least one hydrophobic block is a polystyrene-butadiene-polystyrene triblock copolymer (SBS or PS-PB-PS).

In an embodiment, the at least one styrenic block copolymer comprising at least one block copolymer comprising at least one hydrophobic block is a polystyrene-polydimethylsiloxane diblock copolymer (SD or PS-PDMS) and the at least one styrenic TPE comprising at least one block copolymer comprising at least one hydrophobic block is a polystyrene-poly(ethylene butylene)-polystyrene triblock copolymer (SEBS or PS-PEB-PS).

In an embodiment, the at least one styrenic block copolymer comprising at least one block copolymer comprising at least one hydrophobic block is a polystyrene-polydimethylsiloxane diblock copolymer (SD or PS-PDMS) and the at least one styrenic TPE comprising at least one block copolymer comprising at least one hydrophilic block is a polystyrene-poly(ethylene oxide)-polystyrene triblock copolymer (SOS or PS-PEO-PS).

In an embodiment, the at least one styrenic block copolymer comprising at least one block copolymer comprising at least one hydrophilic block is a polystyrene-polyethylene oxide diblock copolymer (SO or PS-PEO) and the at least one styrenic TPE comprising at least one block copolymer comprising at least one hydrophilic block is a polystyrene-sulfonated butadiene-polystyrene triblock copolymer (SsBS or PS-PsulfB-PS).

The block copolymer species (e.g., SO, SB, SI, SEB, SD, SOS, SBS, SIS, SEBS, SDS) undergo a self-assembly process when heated or thermally processed, in which they organize into a periodic nanostructure of spherical or cylindrical domains on the order of 10-20 nm in size (very small). Without being bound to any one theory, it is believed that the unique mechanical performance and durability of the integrated polymer brush layer at the pore surfaces which defines the pore philicity, phobicity, or chemical functionality, is the result of the shared styrenic (PS) blocks in the two systems helping to bind the block copolymer component to the pore surfaces during the washing steps.

In general, the ratio of the at least one styrenic block copolymer to the at least one styrenic TPE may be 1:99 to 99:1. In various embodiments, the ratio of the one of the at least one styrenic block copolymer to the at least one styrenic TPE is 1:19, 1:1, or 19:1. In yet other embodiments, the ratio of the one of the at least one styrenic block copolymer to the at least one styrenic TPE is 1:4, 1:3, 1:2, 1:1, 1:2, 1:3, 2:3, or 4:1.

Generally, the ratio of the diblock copolymer to TPE, SO to SBS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SO to SEBS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SO to SIS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SO to SDS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SD to SBS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SD to SEBS, is 1:19 to 19:1. In various embodiments, the ratio of the triblock copolymers, SO to SBS, is 1:4, 1:3, 1:2, 1:1, 1:2, 1:3, 2:3, or 4:1.

Generally, the ratio of the diblock copolymer to TPE, SD to SOS, is 1:19 to 19:1. In various embodiments, the ratio of the triblock copolymers, SO to SBS, is 1:4, 1:3, 1:2, 1:1, 1:2, 1:3, 2:3, or 4:1.

### III. Methods of Preparing the Thermoplastic Porous Elastomer (TPPE) Precursor Composites

The present disclosure provides a method for preparing a thermoplastic porous elastomer (TPPE) precursor composite. The method comprises contacting the at least one styrenic block copolymer and at least one styrenic thermoplastic elastomer in a molar ratio from between 1:99 and 99:1 to form a TPPE precursor dry blend. The TPPE precursor dry blend is heated under conditions mechanical mixing, mechanical extrusion or mechanical pressure to form a TPPE precursor melt. The TPPE precursor composite melt is allowed to attain ambient temperature to form an TPPE precursor composite.

### (a) Blending of the TPPE Precursor Dry Blend

The TPPE precursor dry blend may be formed by dissolving the at least one styrenic block copolymer and at least one styrenic thermoplastic elastomer in at least one organic solvent and removing the at least one organic solvent. The organic solvent may be a polar protic solvent, a polar aprotic solvent, a non-polar solvent, or combinations thereof. Suitable examples of polar protic solvents include, but are not limited to alcohols such as methanol, ethanol, isopropanol, n-propanol, isobutanol, n-butanol, s-butanol, t-butanol, and the like; diols such as propylene glycol; organic acids such as formic acid, acetic acid, and so forth; amines such as trimethylamine, or triethylamine, and the like; amides such as formamide, acetamide, and so forth; and combinations of any of the above. Non-limiting examples of suitable polar aprotic solvents include acetonitrile, dichloromethane (DCM), diethoxymethane, N,N-dimethylacetamide (DMAC), N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, 1,4-dioxane, N-methyl-2-pyrrolidinone (NMP), ethyl formate, formamide, hexamethylphosphoramide, N-methylacetamide, N-methylformamide, methylene chloride, nitrobenzene, nitromethane, propionitrile, sulfolane, tetramethylurea, tetrahydrofuran (THF), 2-methyltetrahydrofuran, trichloromethane, and combinations thereof. Suitable examples of non-polar solvents include, but are not limited to, alkane and substituted alkane solvents (including cycloalkanes), aromatic hydrocarbons, esters, ethers, combinations thereof, and the like. Specific non-polar solvents that may be employed include, for example, benzene, butyl acetate, t-butyl methylether, chlorobenzene, chloroform, chloromethane, cyclohexane, dichloromethane, dichloroethane, diethyl ether, ethyl acetate, diethylene glycol, fluorobenzene, heptane, hexane, isopropyl acetate, methyltetrahydrofuran, pentyl acetate, n-propyl acetate, tetrahydrofuran, toluene, and combinations thereof. In particular, the solvent may be benzene or toluene.

The TPPE precursor dry blend may be formed by dissolution in at least one solvent at concentration that may be between about 1 wt % TPPE precursor dry blend and about 20 wt % TPPE precursor dry blend, such as between 1 wt % TPPE precursor dry blend and 2 wt % TPPE precursor dry blend, such as between 2 wt % TPPE precursor dry blend and 3 wt % TPPE precursor dry blend, such as between 3 wt % TPPE precursor dry blend and 4 wt % TPPE precursor dry blend, such as between 4 wt % TPPE precursor dry blend and 5 wt % TPPE precursor dry blend, such as between 5 wt % TPPE precursor dry blend and 6 wt % TPPE precursor dry blend, such as between 6 wt % TPPE precursor dry blend and 7 wt % TPPE precursor dry blend, such as between 7 wt % TPPE precursor dry blend and 8 wt % TPPE precursor dry blend, such as between 8 wt % TPPE precursor dry blend and 9 wt % TPPE precursor dry blend, such as between 9 wt % TPPE precursor dry blend and 10 wt % TPPE precursor dry blend, such as between 10 wt % TPPE precursor dry blend and 11 wt % TPPE precursor dry blend, such as between 11 wt % TPPE precursor dry blend and 12 wt % TPPE precursor dry blend, such as between 12 wt % TPPE precursor dry blend and 13 wt % TPPE precursor dry blend, such as between 13 wt % TPPE precursor dry blend and 14 wt % TPPE precursor dry blend, such as between 14 wt % TPPE precursor dry blend and 15 wt % TPPE precursor dry blend, such as between 15 wt % TPPE precursor dry blend and 16 wt % TPPE precursor dry blend, such as between 16 wt % TPPE precursor dry blend and 17 wt % TPPE precursor dry blend, such as between 17 wt % TPPE precursor dry blend and 18 wt % TPPE precursor dry blend, such as between 18 wt % TPPE precursor dry blend and 19 wt % TPPE precursor dry blend, or such as between 19 wt % TPPE precursor dry blend and 20 wt % TPPE precursor dry blend. The concentration may be between about 5 wt % and 15 wt %, or about 10 wt %.

In the TPPE precursor dry blend, the molar ratio of the at least one styrenic block copolymer and at least one styrenic thermoplastic elastomer may be between about 99:1 and about 1:99, such as between about 99:1 and about 95:5, such as between about 95:5 and about 90:10, such as between about 90:10 and about 85:15, such as between about 85:15 and about 80:20, such as between about 80:20 and about 75:25, such as between about 75:25 and about 70:30, such as between about 70:30 and about 65:35, between about 65:35 and about 60:40, between about 60:40 and about 55:45, between about 55:45 and about 50:50, between about 50:50 and about 55:45, between about 55:45 and about 45:65, between about 45:65 and about 40:60, between about 40:60 and about 35:65, between about 35:65 and about 30:70, between about 30:70 and about 25:75 between about 25:75 and about 20:80=, between about 20:80 and about 15:85, between about 15:85 and about 10:90, between about 10:90 and about 5:95, or between about 5:95 and about 1:99. In particular, the molar ratio may be between about 80:20 and about 20:80, between about 70:30 and about 30:70, between about 60:40 and about 40:60 or at about 50:50. The molar ratio may also be about 4:96, about 3:97, about 2:98, or about 1:99.

### (b) Heating of the Thermoplastic Elastomer Dry Blend

In one embodiment, the TPPE precursor dry blend is processed under a combination of pressure and heat for a period of time to form a TPPE precursor composite. The TPPE precursor dry blend may be heated to a temperature between about 80° C. and about 250° C., such as between about 80° C. and about 90° C., such as between about 90° C. and about 100° C., such as between about 100° C. and about 110° C., between about 110° C. and about 120° C., between about 120° C. and about 130° C., between about 130° C. and about 140° C., between about 140° C. and about 150° C., between about 150° C. and about 160° C., between about 160° C. and about 170° C., between about 160° C. and about 170° C., between about 170° C. and about 180° C., between about 180° C. and about 190° C., between about 190° C. and about 200° C., between about 200° C. and about 210° C., between about 210° C. and about 220° C., between about 220° C. and about 230° C., between about 230° C. and about 240° C., between about 240° C. and about 250° C., between about 250° C. and about 260° C., between about 260° C. and about 270° C., between about 260° C. and about 270° C., between about 270° C. and about 280° C., between about 280° C. and about 290° C., between about 290° C. and about 300° C., between about 300° C. and about 310° C., or between about 310° C. and about 320° C. The temperature may be between about 140° C. and about 160° C., such as about 150° C.

The TPPE precursor dry blend may be heated without or without pressure. If heated under pressure, the TPPE precursor dry blend may be heated under a pressure between about 1000 lbf and about 25000 lbf, such as between about 1000 lbf and about 2000 lbf, between about 2000 lbf and about 3000 lbf, between about 3000 lbf and about 4000 lbf, between about 4000 lbf and about 50000 lbf, between about 5000 lbf and about 6000 lbf, between about 6000 lbf and about 7000 lbf, between about 7000 lbf and about 8000 lbf, between about 8000 lbf and about 9000 lbf, between about 9000 lbf and about 10000 lbf, between about 10000 lbf and about 11000 lbf, between about 11000 lbf and about 12000 lbf, between about 12000 lbf and about 13000 lbf, between about 13000 lbf and about 14000 lbf, between about 14000 lbf and about 15000 lbf, between about 15000 lbf and about 16000 lbf, between about 16000 lbf and about 17000 lbf, between about 17000 lbf and about 18000 lbf, between about 18000 lbf and about 19000 lbf, between about 19000 lbf and about 20000 lbf, between about 20000 lbf and about 21000 lbf, between about 21000 lbf and about 22000 lbf, between about 22000 lbf and about 23000 lbf, between about 23000 lbf and about 24000 lbf, between about 24000 lbf and about 25000 lbf, or at about 15000 lbf. The pressure may be between about 10000 lbf and about 20000 lbf, such as about 15000 lbf.

Additionally, pressure may be applied to samples of the TPPE precursor dry blend placed in a vacuum bag, such that a dynamic reduced pressure of at least 15 Torr inside the bag is achieved during heating with or without pressure. That is, the sample may be placed into a vacuum bag during operation of the press used to heat and squeeze the sample. Doing so has been discovered herein to reduce the number of microbubbles, as well as grain boundary and particle sintering defects in the melt.

Additionally, mechanical mixing may be applied to samples of the TPPE precursor dry blend using an extruding or microcompounding device. That is, the sample may be placed into a twin-screw extruder during heating. Doing so has been discovered control the domain sizes achievable in the TPPE precursor composite. If placed in an extruding device such as a twin screw extruder, the TPPE precursor dry blend may be processed using screw speeds between about 50 rpm and about 250 rpm, such as between about 50 rpm and about 60 rpm, such as between about 60 rpm and about 70 rpm, such as between about 70 rpm and about 80 rpm, such as between about 80 rpm and about 90 rpm, such as between about 90 rpm and about 100 rpm, such as between about 100 rpm and about 110 rpm, between about 110 rpm and about 120 rpm, between about 120 rpm and about 130 rpm, between about 130 rpm and about 140 rpm, between about 140 rpm and about 150 rpm, between about 150 rpm and about 160 rpm, between about 160 rpm and about 170 rpm, between about 160 rpm and about 170 rpm, between about 170 rpm and about 180 rpm, between about 180 rpm and about 190 rpm, between about 190 rpm and about 200 rpm, between about 200 rpm and about 210 rpm, between about 210 rpm and about 220 rpm, between about 220 rpm and about 230 rpm, between about 230 rpm and about 240 rpm, or between about 240 rpm and about 250 rpm. The temperature may be between about 100 rpm and about 200 rpm, such as about 150 rpm.

The TPPE precursor dry blend may be heated with or without pressure, or with or without mechanical mixing for between about 5 minutes and about 60 minutes, such as between about 5 minutes and about 10 minutes, between about 10 minutes and about 15 minutes, between about 15 minutes and about 20 minutes, between about 20 minutes and about 25 minutes, between about 25 minutes and about 30 minutes, between about 30 minutes and about 35 minutes, between about 35 minutes and about 40 minutes, between about 40 minutes and about 45 minutes, between about 45 minutes and about 50 minutes, between about 50 minutes and about 50 minutes or between about 55 minutes and about 60 minutes. In particular, the SO-SOS dry blend may be heated for about 15 minutes, or for about 5 minutes.

The heating may occur in heating-cooling cycles, wherein the TPPE precursor dry blend is heated for a period of time and then allowed to cool to ambient temperature before reheating. For example, the TPPE precursor dry blend may be heated for a period of 5 minutes and then allowed to cool to ambient temperature before reheating. Generally, the dry blend may pass through 1 to 10 cycles. Any combination of these features may be used for processing the TPPE precursor dry blend. For example, the TPPE precursor dry blend may be heated at 150° C. at 5000 lbf in a vacuum bag for 4 heating-cooling cycles.

The sum of the methods used to produce the TPPE precursor composite solid influence the TPPE precursor composite microstructure, particularly the average domain sizes of the at least one styrenic block copolymer and at least one styrenic TPE. Without being bound by theory, it is understood that the average size of the block copolymer and TPE domains can influence the mechanical, physical, or chemical properties exhibited by the TPPE precursor composite, or the porous elastomers subsequently formed. That is, the use of solvent to form the TPPE precursor dry blend, the application of heat to the TPPE precursor dry blend, the application of pressure to the TPPE precursor dry blend, and/or the application of mechanical mixing to the TPPE precursor dry blend can be used to produce a particular microstructure.

The TPPE precursor dry blend may have a microstructure characterized by block copolymer and TPE domains of sizes of about 0.1 microns to about 50 microns. In some embodiments the TPPE precursor dry blend may have a microstructure characterized by block copolymer and TPE domains of sizes of about 0.1 microns to about 5 microns, about 5 microns to about 10 microns, about 10 microns to about 15 microns, about 15 microns to about 20 microns, about 20 microns to about 25 microns, about 25 microns to about 30 microns, about 30 microns to about 35 microns, about 35 microns to about 40 microns, about 40 microns to about 45 microns, or about 45 microns to about 50 microns. In some embodiments the TPPE precursor dry blend may have a microstructure characterized by block copolymer and TPE domains of sizes of about 0.1 microns to about 20 microns. In some embodiments the TPPE precursor dry blend may have a microstructure characterized by block copolymer and TPE domains of sizes of about 0.1 microns to about 10 microns.

### IV. Hydrophilic and Hydrophobic Porous Elastomers

Another aspect of the present disclosure provides for hydrophilic and hydrophobic porous elastomers. The hydrophilic and hydrophobic porous elastomers comprise (a) any one of the TPPE precursor composites as described in Sections II and Ill wherein (b) porosity is generated through selective removal of all unbound styrenic block copolymer from the composite without loss of the original microstructure (porous structure) and (c) all styrenic block copolymer located at the interfaces with the elastomer matrix remains bound to the elastomer surface during the washing steps. As such, the bound block copolymer forms a fixed, and maximally dense, polymer brush layer at all pore surfaces exposed after all unbound block copolymer is removed. Thus, the bound block copolymer is used to impart the desired surface philicity, phobicity, or chemical functionality in the form of a durable high density polymer brush layer integrated into all formed pore surfaces within the elastomer.

In general, the hydrophilicity, hydrophobicity, or chemical functionality of the pore space is imparted by the characteristics of the non-styrenic blocks of the at least one styrenic block copolymer used in the TPPE precursor composite. The TPPE precursor composites are described in more detail in Section (II and Ill) above.

The liquid media used in the generation of porosity are described in more detail in Section (V) below.

In general, the hydrophilic or hydrophobic porous elastomer may have a porosity measured in terms of weight percent of the TPPE precursor composite removed by the liquid media ranging from about 15 wt % to about 20 wt %, from about 20 wt % to about 25 wt %, from about 25 wt % to about 30 wt %, from about 30 wt % to about 35 wt %, from about 35 wt % to about 40 wt %, from about 40 wt % to about 45 wt %, from about 45 wt % to about 50 wt %, from about 50 wt % to about 55 wt %, from about 55 wt % to about 60 wt %, from about 65 wt % to about 70 wt %, from about 70 wt % to about 75 wt %, from about 75 wt % to about 80 wt %, or from about 80 wt % to about 85 wt %.

The porous elastomer may have pore dimensions imparted by the microstructure of the TPPE precursor composite. This microstructure may produce pore sizes of about 0.1 microns to about 50 microns. In some embodiments the porous elastomer may have a pore sizes of about 0.1 microns to about 5 microns, about 5 microns to about 10 microns, about 10 microns to about 15 microns, about 15 microns to about 20 microns, about 20 microns to about 25 microns, about 25 microns to about 30 microns, about 30 microns to about 35 microns, about 35 microns to about 40 microns, about 40 microns to about 45 microns, or about 45 microns to about 50 microns. In some embodiments the porous elastomer may have pore sizes of about 0.1 microns to about 20 microns. In some embodiments the porous elastomer may have pore sizes of about 0.1 microns to about 10 microns.

The hydrophilic porous elastomers have some unique and unexpected properties. The hydrophilic porous elastomers have a lubricious surface meaning the surface is smooth, glassy in appearance, and slippery with a low coefficient of friction.

Generally, the porous elastomers have a bulk modulus averaged over the initial 10% strain of about 0.1 megapascals (MPa) to about 25 MPa. In various embodiments, the porous elastomers have a bulk modulus averaged over the initial 10% strain of about 0.1 MPA to about 25 MPa. In various embodiments, the porous elastomers have a modulus of about 0.1 MPa to about 1 MPa, from about 1 MPa to about 2 MPa, from about 2 MPa to about 3 MPa, from about 3 MPa to about 4 MPa, from about 4 MPa to about 5 MPa, from about 5 MPa to about 6 MPa, from about 6 MPa to about 7 MPa, from about 7 MPa to about 8 MPa, from about 8 MPa to about 9 MPa, from about 9 MPa to about 10 MPa, from about 10 MPa to about 11 MPa, from about 11 MPa to about 12 MPa, from about 12 MPa to about 13 MPa, from about 13 MPa to about 14 MPa, from about 14 MPa to about 15 MPa, from about 15 MPa to about 16 MPa, from about 16 MPa to about 17 MPa, from about 17 MPa to about 18 MPa, from about 18 MPa to about 19 MPa, from about 19 MPa to about 20 MPa, from about 20 MPa to about 21 MPa, from about 21 MPa to about 22 MPa, from about 22 MPa to about 23 MPa, from about 23 MPa to about 24 MPa, or from about 24 MPa to about 25 MPa.

In general, the porous elastomers have a toughness of about 1 MJ/m³ to about 120 MJ/m³. In various embodiments, the porous elastomers have a toughness of about 1 MJ/m³ to about 5 MJ/m³, from about 5 MJ/m³ to about 10 MJ/m³, from about 10 MJ/m³ to about 20 MJ/m³, from about 20 MJ/m³ to about 30 MJ/m³, from about 30 MJ/m³ to about 40 MJ/m³, from about 40 MJ/m³ to about 50 MJ/m³, from about 50 MJ/m³ to about 60 MJ/m³, from about 60 MJ/m³ to about 70 MJ/m³, from about 70 MJ/m³ to about 80 MJ/m³, from about 80 MJ/m³ to about 90 MJ/m³, from about 90 MJ/m³ to about 100 MJ/m³, from about 100 MJ/m³ to about 110 MJ/m³, or from about 110 MJ/m³ to about 120 MJ/m³.

With the above properties, the hydrophilic and hydrophobic porous elastomers are resistant to biofouling, inorganic fouling, organic fouling, fatigue, wear, fracture, degradation, or any combination thereof.

In one embodiment, the porous elastomers may have a fatigue resistance to at least 500,000 compression cycles, such as at least 600,000 compression cycles, such as at least 700,000 compression cycles, such as at least 800,000 compression cycles, such as at least 900,000 compression cycles, such as at least 1,000,000 compression cycles, such as at least 1,500,000 compression cycles, such as at least 2,000,000 compression cycles, such as at least 2,500,000 compression cycles, such as at least 3,000,000 compression cycles, such as at least 3,500,000 compression cycles, such as at least 4,000,000 compression cycles, such as at least 4,500,000 compression cycles, such as at least 5,000,000 compression cycles, or such as at least 10,000,000 compression cycles. In counting the number of compression cycles, the cycles are preferably continuous, but need not be so, having a resting period between shorter runs of cycles.

The compression cycles may operate with at least 30% compression at a frequency of about 2 Hz. The fatigue resistance is characterized by a modulus recoverable to at least 80% of its value before the compression cycles were run, such as to at least 90%, to at least 95% or to at least 99% of its value before the compression cycles were run.

### V. Methods of Preparing the Hydrophilic and Hydrophobic Porous Elastomers

Another aspect of the present disclosure provides for methods of preparing the hydrophilic and hydrophobic porous elastomers. The methods comprise obtaining a TPPE precursor composite as described in Sections (II and Ill) above and removing unbound styrenic block copolymer through successive washes with a liquid medium to produce the porous elastomer.

Removal of the unbound styrenic block copolymer is achieved by contacting the TPPE precursor composite with at least one liquid medium comprising one or more aqueous solvents, aqueous liquid electrolytes, non-aqueous solvents, or non-aqueous electrolytes, or a combination thereof. The liquid medium is used to solvate the unbound styrenic block copolymer and remove it from the TPE matrix through successive soaking and/or washes. The liquid medium is selected such that unbound styrenic block copolymer can be removed from the composite without loss of the original microstructure (porous structure) and all styrenic block copolymer located at the interfaces with the elastomer matrix remains bound to the elastomer surface during the washing steps. As such, the bound block copolymer is retained as a fixed, and maximally dense, polymer brush layer at all pore surfaces exposed upon removal of the unbound block copolymer. The bound block copolymer imparts the desired surface philicity, phobicity, or chemical functionality in the form of a durable high density polymer brush layer integrated into all formed pore surfaces within the elastomer.

The liquid medium is utilized with the TPPE precursor composites to prepare the hydrophilic or hydrophobic porous elastomers. The liquid medium comprises one or more aqueous solvents, aqueous liquid electrolytes, non-aqueous (organic) solvents, or non-aqueous electrolytes, or a combinations thereof.

In general, the liquid medium may comprise one or more aqueous or non-aqueous (organic) solvents in combination with or without water. The one or more solvents may be a polar protic solvent, a polar aprotic solvent, a non-polar solvent, or combinations thereof. Suitable examples of polar protic solvents include but are not limited to water; alcohols such as methanol, ethanol, isopropanol, n-propanol, iso-butanol, n-butanol, s-butanol, t-butanol, and the like; diols such as propylene glycol; organic acids such as formic acid, acetic acid, and so forth; amines such as trimethylamine, or triethylamine, and the like; amides such as formamide, acetamide, and so forth; and combinations of any of the above. Non-limiting examples of suitable polar aprotic solvents include acetonitrile, dichloromethane (DCM), diethoxymethane, N,N-dimethylacetamide (DMAC), N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, 1,4-dioxane, N-methyl-2-pyrrolidinone (NMP), ethyl formate, formamide, hexamethylphosphoramide, N-methylacetamide, N-methylformamide, methylene chloride, nitrobenzene, nitromethane, propionitrile, sulfolane, tetramethylurea, tetrahydrofuran (THF), 2-methyltetrahydrofuran, trichloromethane, and combinations thereof. Suitable examples of non-polar solvents include, but are not limited to, alkane and substituted alkane solvents (including cycloalkanes), aromatic hydrocarbons, esters, ethers, combinations thereof, and the like. Specific non-polar solvents that may be employed include, for example, benzene, butyl acetate, t-butyl methyl ether, chlorobenzene, chloroform, chloromethane, cyclohexane, dichloromethane, dichloroethane, diethyl ether, ethyl acetate, diethylene glycol, fluorobenzene, heptane, hexane, isopropyl acetate, methyl tetrahydrofuran, pentyl acetate, n-propyl acetate, tetrahydrofuran, toluene, and combinations thereof.

The non-aqueous liquid electrolyte may be a room-temperature ionic liquid (RTIL), which are relatively non-volatile, highly tunable molten salts whose melting points are below ambient temperature. RTILs are solvents with low viscosities (10-100 cP), low melting points, a range of densities, and relatively small molar volumes. Generally, RTILs consist of a cation and an anion.

The liquid medium may comprise a non-aqueous liquid electrolyte. Suitable liquid electrolytes include imidazolium-based ionic liquids.

The liquid electrolyte medium may further comprise one or more solvents, liquid electrolytes, or a combination thereof.

In one embodiment, the aqueous solvent may be water. In another embodiment, the aqueous solvent may be a buffer. Examples of suitable buffers include but are not limited to phosphate-buffered saline (PBS). Ringer's solution, or combinations thereof. In other embodiments, the aqueous solvent may be water with a surfactant. A non-limiting example of a suitable surfactant includes sodium dodecylsulfate.

In one embodiment, the non-aqueous electrolyte may be the RTIL 1-ethyl-3-methyl imidazolium bis(trifluoromethane)sulfonamide ([EMIM][TFSI]).

The TPPE precursor composite may be contacted with the liquid medium at a temperature above −10° C. and below about 160° C., such as above 0° C. and below about 50° C., or at about 25° C. The temperature may be between about −10° C. and about −5° C., between about −5° C. and about 0° C., between about 0° C. and about 5° C., between about 5° C. and about 10° C., between about 10° C. and about 15° C., between about 15° C. and about 20° C., between about 20° C. and about 25° C., between about 25° C. and about 30° C., between about 30° C. and about 35° C., between about 35° C. and about 40° C., between about 40° C. and about 45° C., between about 45° C. and about 50° C., between about 50° C. and about 55° C., between about 55° C. and about 60° C., between about 60° C. and about 65° C., between about 65° C. and about 70° C., between about 70° C. and about 75° C., between about 75° C. and about 80° C., between about 80° C. and about 85° C., between about 85° C. and about 90° C., between about 90° C. and about 95° C., between about 95° C. and about 100° C., between about 100° C. and about 105° C., between about 105° C. and about 110° C., between about 110° C. and about 115° C., between about 115° C. and about 120° C., between about 120° C. and about 125° C., between about 125° C. and about 130° C., between about 130° C. and about 135° C., between about 135° C. and about 140° C., between about 140° C. and about 145° C., between about 145° C. and about 150° C., between about 150° C. and about 155° C., or between about 155° C. and about 160° C.

The washing of the TPPE precursor composite may involve more than one washing cycles. For example, the liquid medium may be removed and replaced with new liquid medium more than one time until most or significantly all of the unbound sytrenic block copolymer is removed. In some embodiments the TPPE precursor composite is washed at least one time, at least two times, at least three times, at least four times, at least five times, at least six times, at least seven times, at least eight times, at least nine time, or at least ten times.

Each wash cycle may be for the same time interval or different intervals. In some embodiments, each wash cycle (time the TPPE precursor composite is contacted with the liquid medium) is about 1 minute, about 5 minutes, about 10 minutes, about 15 minutes, about 20 minutes, about 25 minutes, about 30 minutes, about 35 minutes, about 40 minutes, about 45 minutes, about 50 minutes, about 55 minutes, or about 60 minutes. In some embodiments, each wash cycle is greater than 60 minutes. In some embodiments, each wash cycle is about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. In some embodiments, each wash cycle may be greater than about 72 hours. For example, the wash cycle time may be about 72 hours, about 75 hours, about 80 hours, about 85 hours, about 90 hours, about 95 hours, or about 100 hours.

In some embodiments, the total amount of time the TPPE precursor composite may be contacted with the liquid medium (all washing steps combined) is about 1 minute, about 5 minutes, about 10 minutes, about 15 minutes, about 20 minutes, about 25 minutes, about 30 minutes, about 35 minutes, about 40 minutes, about 45 minutes, about 50 minutes, about 55 minutes, or about 60 minutes. In some embodiments, the total amount of time the TPPE precursor composite may be contacted with the liquid medium is greater than 60 minutes. In some embodiments, the total amount of time the TPPE precursor composite may be contacted with the liquid medium is about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. In some embodiments, the TPPE precursor composite may be contacted with the liquid medium for greater than about 72 hours. For example, the total contact time may be about 72 hours, about 75 hours, about 80 hours, about 85 hours, about 90 hours, about 95 hours, or about 100 hours.

The washing step may remove at least 1% to at least 100% of the unbound sytrenic block copolymer. In some embodiments, the washing step may remove at least 90% of the unbound sytrenic block copolymer, at least 95% of unbound sytrenic block copolymer, at least 96% of the unbound sytrenic block copolymer, at least 97% of the unbound sytrenic block copolymer, a at least 98% of the unbound sytrenic block copolymer, at least 99% of the unbound sytrenic block copolymer, or at least 100% of the unbound sytrenic block copolymer. In some embodiments, the washing step may remove essentially all of the unbound sytrenic block copolymer. In some embodiments, the washing step may remove all detectable amounts of the unbound sytrenic block copolymer. In some embodiments, the washing step may remove all of the unbound sytrenic block copolymer.

After the removal of the unbound styrenic block copolymer is achieved by contacting the TPPE precursor composite with at least one liquid medium to achieve the porous elastomer, the porous elastomer may be dried. Such drying may remove any residual liquid medium from the porous elastomer. The drying may be accomplished by methods known in the art, such as air drying or vacuum drying. After drying, the porous elastomer retains its porous structure.

In some embodiments, the drying step removes about 90% or greater of the liquid medium, about 95% or greater of the liquid medium, about 96% or greater of the liquid medium, about 97% or greater of the liquid medium, about 98% or greater of the liquid medium, about 99% or greater of the liquid medium, or about 100% of the liquid medium. In some embodiments, the drying step may remove essentially all of the liquid medium. In some embodiments, the drying step may remove all detectable amounts of the liquid medium. In some embodiments, the drying step may remove all of the liquid medium.

### VI. Applications

The hydrophilic and hydrophobic porous elastomers disclosed herein may be used as liquid phase separation membranes for selective separations particles, proteins, protein assemblies, viruses, molecules, or ions from a liquid medium or filtrate, biomedical devices such as tissue or cell growth scaffolds or flexible wound dressing materials, and porous coating materials for enhanced adhesion or surface interactions.

The hydrophilic and hydrophobic porous elastomers disclosed herein may also be used as supported liquid membranes (SLMs) when the pore space is saturated with a liquid medium, typically a liquid electrolyte. SLMs are particularly useful as gas phase separation membranes for selective removal of CO₂ or CH₄ from light gas streams, or as elastic battery separators or flexible ionic conductors.

### (a) Liquid Phase Separation Membranes

One aspect of the present disclosure provides liquid phase separation membranes prepared using the TPPE precursor composites which are then converted to hydrophilic or hydrophobic porous elastomers. Such separation membranes may include but are not limited to membranes used to selectively separate particles, proteins, protein assemblies, viruses, molecules, or ions from a liquid medium or filtrate.

The beneficial properties of the disclosed hydrophilic and hydrophobic porous elastomers including controlled porosity, pore sizes, and pore size distributions, make them especially suited as liquid phase separation membranes.

Other beneficial properties of the disclosed hydrophilic and hydrophobic porous elastomers including their tailorable pore surface philicity, phobicity, and chemical functionality through choice of block copolymer used in the TPPE precursor composite, also make them especially suited as liquid phase separation membranes.

Yet other beneficial properties of the disclosed hydrophilic and hydrophobic porous elastomers including intrinsic resistance to fouling with respect to biological, inorganic, or organic material in the filtrate because of the dense brush layers of hydrophilic or hydrophobic polymer coating the pore surfaces, also make them especially suited as liquid phase separation membranes.

Yet other beneficial properties of the disclosed hydrophilic and hydrophobic porous elastomers including mechanical toughness, resistance to fatigue and fracture, and intrinsic elasticity and flexibility, also make them especially suited as liquid phase separation membranes.

### (b) Biomedical Device Applications

Another aspect of the present disclosure provides biomedical devices and implants prepared using the hydrophilic and hydrophobic porous elastomers detailed above. Such biomedical devices may include but are not limited to tissue and cell growth scaffolds, wound healing dressings, hernia patches, medical device coatings, or medical implants. Biomedical implants may include, but are not limited to, soft tissue replacements such as intervertebral discs, meniscus, labria, or fibrocartilage.

One example of a biomedical device is a wound dressing comprising disclosed porous elastomer detailed above. The porous elastomer may be saturated with therapeutic solutions containing therapeutic agents or clotting factors, antibiotics or pain management agents. Pore size and porosity can be tailored to control delivery rates and pore functionality can be used to tailor therapeutic solution compatibility.

Another example of a biomedical device is a synthetic fibrocartilage replacement such as that found in the meniscus of the knee or the intervertebral disc, prepared using the porous elastomers detailed above.

Yet another example of a biomedical device is a tissue engineering scaffold or a medical device coating used to stimulate or instigate the growth of cells or tissues in vivo or in vitro.

Beneficial properties of the disclosed porous elastomer in such application are that it may be shaped or printed using an injection-molder or a 3D printer into the specific size of the tissue replacement for each individual patient, and the chemical functionality of the block copolymer comprising the TPPE precursor composite tailored for cell and tissue ingrowth to enhance long term integration into the body.

Other beneficial properties of the disclosed porous elastomers including their tailorable pore surface philicity, phobicity, and chemical functionality through choice of block copolymer used in the TPPE precursor composite, also make them especially suited for biomedical device applications.

Yet other beneficial properties of the disclosed hydrophilic and hydrophobic porous elastomers including mechanical toughness, resistance to fatigue and fracture, and intrinsic elasticity and flexibility, also make them especially suited for the described biomedical applications.

Additionally, the ability to co-extrude the disclosed composites with defined concentrations of therapeutic agents, or to impregnate the pore space simply by swelling in the presence of such agents provides a range of opportunities in the biomedical device market. Such opportunities include, for example, the integration of the disclosed porous elastomer as a skirt material in an aortic valve replacement.

### (c) Supported Liquid Membranes

The hydrophilic and hydrophobic porous elastomers disclosed herein may also be used as supported liquid membranes (SLMs) when the pore space is saturated with a liquid medium. SLMs are particularly useful as gas phase separation membranes for selective removal of CO₂ or CH₄ from light gas streams, or as elastic battery separators or flexible ionic conductors.

The liquid medium of the SLM may comprise a liquid electrolyte. Suitable liquid electrolytes include imidazolium-based ionic liquids.

In general, the liquid electrolyte medium may further comprise one or more solvents, liquid electrolytes, or a combination thereof.

The liquid electrolyte may be a room-temperature ionic liquid (RTIL), which are relatively non-volatile, highly tunable molten salts whose melting points are below ambient temperature. RTILs are solvents with low viscosities (10-100 cP), low melting points, a range of densities, and relatively small molar volumes. Generally, RTILs consist of a cation and an anion.

The cation in the RTIL may be imidazolium, phosphonium, ammonium, and pyridinium. In particular embodiments, the RTIL comprises an imidazolium cation; that is, the RTIL is an imidazolium-based ionic liquid. Each cation may be substituted with one or more R groups, such as an imidazolium having the formula [Rmim] or [R₂mim], wherein “mim” references the imidiazolium. The R group may comprise one or more n-alkyl, branched alkyl, alkenyl, such as vinyl or allyl, alkynyl, fluoroalkyl, benzyl, styryl, hydroxyl, ether, amine, nitrile, silyl, siloxy, oligo(ethylene glycol), isothiocyanates, and sulfonic acids. In particular, the R group may be an alkyl selected from methyl or ethyl.

The RTIL may be functionalized with one, two, three, or more oligo(alkylene glycol) substituents, such as an oligo(ethylene glycol). Alternatively, the oligo(alkylene glycol) may be a methylene glycol or a propylene glycol.

A vicinal diol substituent on the RTILs may provide greater aqueous solubility and possible water miscibility.

Polymerizable RTILs may be provided choosing one or more R groups on the cation from a styrene, vinyl, allyl, or other polymerizable group.

Examples of suitable cations in the RTIL include, but are not limited to, 1-ethyl-3-methyl imidazolium ([EMIM]), 1-hexyl-3-methyl imidazolium ([HMIM]), 1-vinyl-3-ethyl-imidazolium ([VEIM]), 1-allyl-3-methyl-imidazolium ([AMIM]), 1-hexyl-3-butyl-imidazolium ([HBIM]), 1-vinyl-3-methylimidazolium ([VMIM]), 1-hydroxyundecanyl-3-methylimidazolium ([(C₁₁OH)MIM]), tetrabutylphosphonium ([P4444]), 1-(2,3-dihydroxypropyl)-alkyl imidazolium ([(dhp)MIM]), and combinations thereof. For example, the cation may be 1-ethyl-3-methyl imidazolium ([EMIM]). The cation may be 1-hexyl-3-methyl imidazolium ([HMIM]). The cation may be 1-vinyl-3-ethyl-imidazolium ([VEIM]). The cation may be 1-allyl-3-methyl-imidazolium ([AMIM]). The cation may be 1-hexyl-3-butyl-imidazolium ([HBIM]), 1-vinyl-3-methylimidazolium ([VMIM]). The cation may be 1-hydroxyundecanyl-3-methylimidazolium ([(C₁₁OH)MIM]). The cation may be tetrabutylphosphonium ([P4444]). The cation may also be 1-(2,3-dihydroxypropyl)-alkyl imidazolium ([(dhp)MIM]).

Suitable anions (X) in the RTIL include, but are not limited to, triflate (OTf), dicyanamide (DCA), tricyanomethanide (TCM), tetrafluoroborate (BF4), hexafluorophosphate (PF6), taurinate (Tau), and bis(trifluoromethane)sulfonimide (TSFI). For example, the anion may be triflate (OTf). The anion may be dicyanamide (DCA). The anion may be tricyanomethanide (TCM). The anion may be tetrafluoroborate (BF4). The anion may be hexafluorophosphate (PF6). The anion may be taurinate (Tau). The anion may be bis(trifluoromethane)sulfonimide (TSFI).

Any combination of cations and anions described herein may be used to form a suitable RTIL. Examples of suitable RTILs include, but are not limited to, 1-ethyl-3-methyl imidazolium bis(trifluoromethane)sulfonamide ([EMIM][TFSI]), 1-hexyl-3-methyl imidazolium bis(trifluoromethane)sulfonamide ([HMIM][TFSI]), 1-vinyl-3-ethyl-imidazolium bis(trifluoromethane)sulfonamide ([VEIM][TFSI]), 1-allyl-3-methyl-imidazolium bis(trifluoromethane)sulfonamide ([AMIM][TFSI]), 1-hexyl-3-butyl-imidazolium bis(trifluoromethane)sulfonamide ([HBIM][TFSI]), 1-vinyl-3-methylimidazolium bis(trifluoromethane)sulfonamide ([VMIM][TFSI]), 1-hydroxyundecanyl-3-methylimidazolium bis(trifluoromethane)sulfonamide ([(C₁₁OH)MIM][TFSI]), 1-ethyl-3-methylimidazolium tricyanomethanide ([EMIM][TCM]), tetrabutylphosphonium taurinate, ([P4444][Tau]), 1-ethyl-3-methylimidazolium dicyanamide ([EMIM][DCA]), 1-(2,3-dihydroxypropyl)-alkyl imidazolium dicyanamide ([(dhp)MIM][DCA]), 1-(2,3-dihydroxypropyl)-3-alkyl imidazolium tetrafluoroborate ([(dhp)MIM][BF4]), 1-(2,3-dihydroxypropyl)-3-alkyl imidazolium bis(trifluoromethane)sulfonimide ([(dhp)MIM][TFSI]), 1-(2,3-dihydroxypropyl)-3-alkyl imidazolium hexafluorophosphate ([(dhp)MIM][PF6]), or combinations thereof.

For example, the RTIL may be 1-ethyl-3-methyl imidazolium bis(trifluoromethane)sulfonamide ([EMIM][TFSI]). The RTIL may be 1-hexyl-3-methyl imidazolium bis(trifluoromethane)sulfonamide ([HMIM][TFSI]). The RTIL may be 1-vinyl-3-ethyl-imidazolium bis(trifluoromethane)sulfonamide ([VEIM][TFSI]). The RTIL may be 1-allyl-3-methyl-imidazolium bis(trifluoromethane)sulfonamide ([AMIM][TFSI]). The RTIL may be 1-hexyl-3-butyl-imidazolium bis(trifluoromethane)sulfonamide ([HBIM][TFSI]). The RTIL may be 1-vinyl-3-methylimidazolium bis(trifluoromethane)sulfonamide ([VMIM][TFSI]). The RTIL may be 1-hydroxyundecanyl-3-methylimidazolium bis(trifluoromethane)sulfonamide ([(CH)MIM][TFSI]). The RTIL may be 1-ethyl-3-methylimidazolium tricyanomethanide ([EMIM][TCM]). The RTIL may be tetrabutylphosphonium taurinate. The RTIL may be ([P4444][Tau]). The RTIL may be 1-ethyl-3-methylimidazolium dicyanamide ([EMIM][DCA]). The RTIL may be 1-(2,3-dihydroxypropyl)-alkyl imidazolium dicyanamide ([(dhp)MIM][DCA]). The RTIL may be 1-(2,3-dihydroxypropyl)-3-alkyl imidazolium tetrafluoroborate ([(dhp)MIM][BF4]). The RTIL may be 1-(2,3-dihydroxypropyl)-3-alkyl imidazolium bis(trifluoromethane)sulfonimide ([(dhp)MIM][TFSI]). The RTIL may also be 1-(2,3-dihydroxypropyl)-3-alkyl imidazolium hexafluorophosphate ([(dhp)MIM][PF6]). These exemplary RTILs are further illustrated below at Table 1.

TABLE 1
Exemplary RTILs.

| Abbreviation | Chemical Name | Structure |
|---|---|---|
| [EMIM][TSFI] | 1-ethyl-3-methylimidazolium bis(trifluoromethane)sulfonimide | 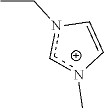 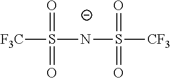 [SMILES: O=S(=O)(NS(=O)(=O)C(F)(F)F)C(F)(F)F] |
| [VEIM][TSFI] | 1-vinyl-3-ethyl-imidazolium bis(trifluoromethane)sulfonimide | 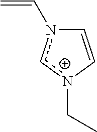 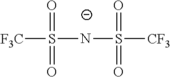 [SMILES: O=S(=O)(NS(=O)(=O)C(F)(F)F)C(F)(F)F] |
| [HMIM][TSFI] | 1-hexyl-3-methyl-imidazolium bis(trifluoromethane)sulfonimide | 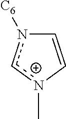 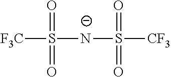 [SMILES: O=S(=O)([N-]S(=O)(=O)C(F)(F)F)C(F)(F)F] |
| [AMIM][TSFI] | 1-allyl-3-methyl-imidazolium bis(trifluoromethane)sulfonimide | 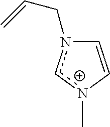 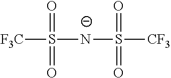 [SMILES: O=S(=O)([N-]S(=O)(=O)C(F)(F)F)C(F)(F)F] |
| [HBIM][TSFI] | 1-hexyl-3-butyl-imidazolium bis(trifluoromethane)sulfonimide | 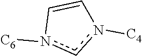 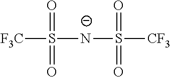 [SMILES: O=S(=O)([N-]S(=O)(=O)C(F)(F)F)C(F)(F)F] |
| [VMIM][TSFI] | 1-vinyl-3-methylimidazolium bis(trifluoromethane)sulfonimide | 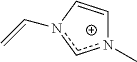 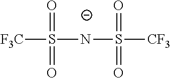 [SMILES: O=S(=O)(NS(=O)(=O)C(F)(F)F)C(F)(F)F] |
| [(C₁₁OH)MIM][TSFI] | 1-hydroxyundecanyl-3-methylimidazolium bis(trifluoromethane)sulfonimide | 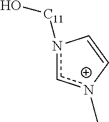 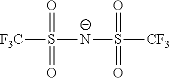 [SMILES: O=S(=O)([N-]S(=O)(=O)C(F)(F)F)C(F)(F)F] |
| [EMIM][TCM] | 1-ethyl-3-methylimidazolium tricyanomethanide | 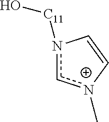 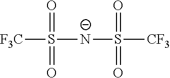 [SMILES: O=S(=O)([N-]S(=O)(=O)C(F)(F)F)C(F)(F)F] |
| [P4444][Tau] | tetrabutylphosphonium taurinate | 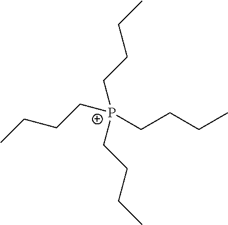 [SMILES: CCCC[P+](CCCC)(CCCC)CCCC] 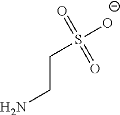 |
| [EMIM][DCA] | 1-ethyl-3-methylimidazolium dicyanamide | 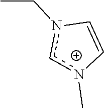 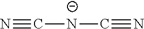 |
| [DMIM][Tf2N] or [DEIM][Tf2N] | 1-(2,3-dihydroxypropyl)-3- methylimidazolium bis(trifluoromethanesulfonimide) or 1-(2,3-dihydroxypropyl)-3-ethylimidazolium bis(trifluoromethanesulfonimide) | 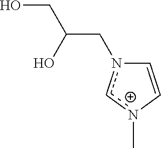 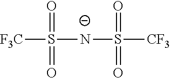 [SMILES: O=S(=O)([N-]S(=O)(=O)C(F)(F)F)C(F)(F)F] |
| [DMIM][BF4] or [DEIM][BF4] | 1-(2,3-dihydroxypropyl)-3- methylimidazolium tetrafluoroborate or 1-(2,3-dihydroxypropyl)-3-ethylimidazolium tetrafluoroborate | 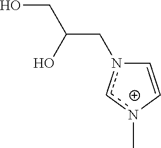 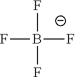 |
| [DMIM][DCA] or [DEIM][DCA] | 1-(2,3-dihydroxypropyl)-3- methylimidazolium dicyanamide or 1-(2,3-dihydroxypropyl)-3-ethylimidazolium dicyanamide | 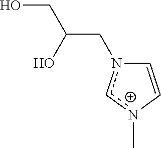 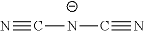 |
| [DMIM][PF6] or [DEIM][PF6] | 1-(2,3-dihydroxypropyl)-3- methylimidazolium hexafluorophosphate or 1-(2,3-dihydroxypropyl)-3-ethylimidazolium hexafluorophosphate | 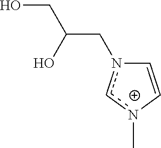 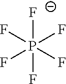 |

The RTIL may be [Rmim][TSFI]. In particular, the RTIL may be [Rmim][TSFI], wherein R is ethyl; that is, the RTIL may be 1-ethyl-3-methyl imidazolium bis(trifluoromethanesulfonyl)imide ([EMIM][TSFI]).

The liquid medium may be a mixture of an aqueous medium and an RTIL. For such mixtures, the volume ratio may be between about 99:1 and about 1:99 aqueous medium/RTIL, such as between about 99:1 and about 95:5 aqueous medium/RTIL, between about 95:5 and about 90:10 aqueous medium/RTIL, between about 90:10 and about 85:15 aqueous medium/RTIL, between about 85:15 and about 80:20 aqueous medium/RTIL, between about 80:20 and about 75:25 aqueous medium/RTIL, between about 75:25 and about 70:30 aqueous medium/RTIL, between about 70:30 and about 65:35 aqueous medium/RTIL, between about 65:35 and about 60:40 aqueous medium/RTIL, between about 60:40 and about 55:45 aqueous medium/RTIL, between about 55:45 and about 50:50 aqueous medium/RTIL, between about 50:50 and about 55:45 aqueous medium/RTIL, between about 55:45 and about 45:65 aqueous medium/RTIL, between about 45:65 and about 40:60 aqueous medium/RTIL, between about 40:60 and about 35:65 aqueous medium/RTIL, between about 35:65 and about 30:70 aqueous medium/RTIL, between about 30:70 and about 25:75 aqueous medium/RTIL, between about 25:75 and about 20:80 aqueous medium/RTIL, between about 20:80 and about 15:85 aqueous medium/RTIL, between about 15:85 and about 10:90 aqueous medium/RTIL, between about 10:90 and about 5:95 aqueous medium/RTIL, or between about 5:95 and about 1:99 aqueous medium/RTIL. In particular, the molar ratio may between about 70:30 and about 20:80 aqueous medium/RTIL, between about 60:40 and about 30:70 aqueous medium/RTIL, or at about 40:60 aqueous medium/RTIL.

In general, the liquid electrolyte medium may further comprise one or more non-aqueous solvents. The one or more non-aqueous solvents may be a polar protic solvent, a polar aprotic solvent, a non-polar solvent, or combinations thereof. Suitable examples of polar protic solvents include but are not limited to alcohols such as methanol, ethanol, isopropanol, n-propanol, iso-butanol, n-butanol, s-butanol, t-butanol, and the like; diols such as propylene glycol; organic acids such as formic acid, acetic acid, and so forth; amines such as trimethylamine, or triethylamine, and the like; amides such as formamide, acetamide, and so forth; and combinations of any of the above. Non-limiting examples of suitable polar aprotic solvents include acetonitrile, dichloromethane (DCM), diethoxymethane, N,N-dimethylacetamide (DMAC), N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, 1,4-dioxane, N-methyl-2-pyrrolidinone (NMP), ethyl formate, formamide, hexamethylphosphoramide, N-methylacetamide, N-methylformamide, methylene chloride, nitrobenzene, nitromethane, propionitrile, sulfolane, tetramethylurea, tetrahydrofuran (THF), 2-methyltetrahydrofuran, trichloromethane, and combinations thereof. Suitable examples of non-polar solvents include, but are not limited to, alkane and substituted alkane solvents (including cycloalkanes), aromatic hydrocarbons, esters, ethers, combinations thereof, and the like. Specific non-polar solvents that may be employed include, for example, benzene, butyl acetate, t-butyl methyl ether, chlorobenzene, chloroform, chloromethane, cyclohexane, dichloromethane, dichloroethane, diethyl ether, ethyl acetate, diethylene glycol, fluorobenzene, heptane, hexane, isopropyl acetate, methyl tetrahydrofuran, pentyl acetate, n-propyl acetate, tetrahydrofuran, toluene, and combinations thereof.

The SLMs formed with liquid electrolytes have a unique and unexpected property. The CO₂/N₂ selectivity and the CH₄/N₂ selectivity of the SLM is comparable to the liquid electrolyte medium. In some embodiments, the selectivities are equal to or higher than the liquid electrolyte medium.

The SLMs formed with liquid electrolytes have another unique and unexpected property. The CO₂ permeability and the CH₄ permeability of the SLM is comparable to the liquid electrolyte medium. In some embodiments, the selectivities are equal to or higher than the liquid electrolyte medium.

The SLMs formed with liquid electrolytes have yet another unique and unexpected property. The ionic conductivity SLM is comparable to the liquid electrolyte medium. In some embodiments, the ionic conductivity is equal to or higher than the liquid electrolyte medium.

### (d) Gas Phase Separation Membranes

One example of a separation membrane is a supported liquid membrane (SLM) as described above. SLMs are particularly useful as light gas separation membranes used to selectively separate CO₂ or CH₄ from a gas stream.

The hydrophilic and hydrophobic porous membranes disclosed may be used as SLMs with liquid electrolytes as described for the separation of light gases, such as mixtures of carbon dioxide (CO₂), methane (CH₄), ethane, propane, butane, water, oxygen (O₂), nitrogen and argon. The mixture of light gases may be crude natural gas (such as that produced at a natural gas well), flue gas, or atmosphere. In particular, CO₂ is emitted from coal-fired power plants in “flue gas,” which contains 10-15% CO₂ along with N₂ (70-80%), water, O₂, and other trace gases.

Existing technologies for the separation of CO₂ from flue gas include aqueous amine scrubbing, pressure swing absorption, and cryogenic distillation. Implementing these technologies requires about 30% of the energy produced by the power plant, making them economically unsustainable. Membrane-based alternatives are being investigated at the pilot plant scale as a superior solution for separating CO₂ from flue gas. Successful membrane technologies offer several advantages over traditional methods for lower operating energies, modular scalability, a reduced physical footprint, and elimination of volatile chemicals.

To successfully apply to flue gas separations, membranes must have high CO₂ permeance and reasonable CO₂/N₂ selectivities (>20:1), be processable into substantially defect-free thin films, have long operating lifetimes, and have reasonable production costs. The range of CO₂/N₂ selectivities can and will vary. Generally, the selectivity may be between about 20:1 and about 60:1, such as about 20:1 to about 25:1, about 25:1 to about 30:1, about 30:1 to about 35:1, about 35:1 to about 40:1, about 40:1 to about 45:1, about 45:1 to about 50:1, about 50:1 to about 55:1, or about 55:1 to about 60:1. The selectivity may be greater than about 20:1. The selectivity may be less than about 60:1.

New membrane materials may be screened by measuring single-gas permeability and selectivity, which are compared with performance values of existing materials using a comprehensive Robeson Plot, which are used in membrane science to gauge the performance of a membrane relative other materials as well to measure progress in a particular separation over time. Many other critical properties, such as mechanical stability over time, processability into free-standing or stable thin films, and compatibility with current module configurations, may also be addressed.

The CO₂/N₂ separation performance of the porous elastomer SLMs disclosed herein was characterized by transmembrane pressure differentials exceeding about 400 kPa. porous elastomer SLMs disclosed herein exhibit figures of merit pushing the limits of the 2008 Robeson plot upper bound, while maintaining exceptional mechanical integrity, even in the saturated state. The porous elastomer SLMs disclosed herein exhibit unique tensile and compressive properties under cyclic loading conditions.

### (e) Battery Separators

The hydrophilic and hydrophobic porous membranes disclosed may be used as SLMs with liquid electrolytes as described for battery separators and flexible ionic conductors.

The SLMs prepared from hydrophilic and hydrophobic porous elastomers disclosed herein may also be used to make separators in battery cells or fuel cells. The battery separator is a critical component in liquid electrolyte batteries and is placed between the positive electrode and the negative electrode to prevent physical contact of the electrodes while enabling free ionic transport and isolating electronic flow. Generally, a battery separator is a microporous layer consisting of either a polymeric membrane or a non-woven fabric mat. The battery separators described herein are chemically and electrochemically stable towards the electrolyte and electrode materials under ordinary battery operation. These battery separators are also mechanically strong enough to withstand the high tension during the battery assembly operation.

Structurally, the battery separator has sufficient porosity to absorb liquid electrolyte for the high ionic conductivity. One of skill in the art would recognize that the battery separator adds electrical resistance and takes up space inside the battery, which can adversely affect battery performance. Therefore, selection of an appropriate separator is critical to the battery performance, including energy density, power density, cycle life and safety. The battery separators described herein satisfy these performance criteria. Especially for high energy and power densities, the battery separator must be very thin and highly porous while still remaining mechanically strong. For battery safety, the battery separator may shut the battery down if overheated, such as the occasional short circuit, so that thermal runaway can be avoided. The shutdown function can be obtained through a multilayer design of the battery separator, in which at least one layer melts to close the pores below the thermal runaway temperature and the other layer provides mechanical strength to prevent physical contact of the electrodes.

The function of a battery separator described herein is to prevent physical contact of the positive and negative electrodes while permitting free ion flow. The battery separator itself does not participate in any cell reactions, but its structure and properties considerably affect the battery performance, including the energy and power densities, cycle life, and safety.

The battery separator materials described herein, namely the porous elastomers, are chemically stable against the electrolyte and electrode materials under ordinary battery operation, especially under the strongly reductive and oxidative environments when the battery is fully charged. Meanwhile, the battery separator does not degrade or lose mechanical strength during ordinary battery operation over the typical lifetime of a battery. A method for one of skill in the art to verify chemical stability is by calendar life testing.

The low thickness of the battery separators described herein permits high energy and power densities. Although a low thickness may adversely affect the mechanical strength and safety of the separator, the porous elastomers are strong enough for this application. A thickness of 25.4 μm (1 mil) is the standard for consumer rechargeable batteries. As such, battery separators described herein may have a thickness between about 10 μm and about 40 μm, such as between about 10 μm and about 20 μm, between about 20 μm and about 30 μm, or between about 30 μm and about 40 μm. The battery separators may have a uniform thickness across the area of the separators, thereby aiding long cycle life of the batteries in which it is used. The thickness can be measured using the T411 om-83 method developed under the auspices of the Technical Association of the Pulp and Paper Industry.

The battery separators described herein may wet easily in the liquid medium and retain the liquid medium permanently (over the typical lifetime of a battery). The former facilitates the process of electrolyte filling in battery assembly and the latter increases cycle life of the battery. There is no generally accepted test for battery separator wettability. Placing a droplet of electrolyte on the separator and observing whether or not the droplet quickly wicks into the battery separator is an easy way to indicate sufficient wettability.

The battery separators lay flat and do not bow or skew when laid out and soaked with liquid medium. The battery separator remain stable in dimensions over a wide temperature range during the typical lifetime of a battery.

Most battery separator cost is in the manufacturing process. The process described herein is cost-effective, in that it reduces the battery separator cost. Many properties above are associated with each other and may be in a trade-off relationship. For example, reducing the separator thickness increases battery energy and power densities, but it may also lower the mechanical strength of the battery separator. In practical applications, one of skill in the art would understand to appropriately weight the requirements above among the performance, safety and cost.

As various changes could be made in the above-described methods without departing from the scope of the disclosure, it is intended that all matter contained in the above description and in the examples given below, shall be interpreted as illustrative and not in a limiting sense.

### EXAMPLES

The following examples are included to demonstrate preferred embodiments of the disclosure. It should be appreciated by those of skill in the art that the techniques disclosed in the examples that follow represent techniques discovered by the inventor to function well in the practice of the present disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the present disclosure.

### Examples 1-12

### Materials and Synthetic Methods

All reagents were purchased from Millipore-Sigma and all solvents were purchased from Fisher Chemical unless otherwise stated. Styrene monomer (99%, 50 ppm p-tert-butylcatechol inhibitor) was purified at 40° C. by distillations under static vacuum (15-30 mTorr) from di-n-butylmagnesium (1.0 M in heptane). Ethylene oxide (99.5+%, compressed gas) was purified by successive distillations from di-n-butylmagnesium (1.0 M in heptane) at 0-5° C. Tetrahydrofuran (THF) was sparged with argon (10 psi) for 45 min and then purified over two neutral alumina molecular sieve columns (Glass Contour, Inc.). Cyclohexane (CHX) was degassed with argon and purified through a neutral alumina column followed by a Q5 copper(II) oxide catalyst column (Glass Contour, Inc.). Other common chemicals and solvents were used as received unless otherwise stated. Ultra-high purity argon (99.998%, Airgas) was passed through a column of 5 Å molecular sieves and oxygen-absorbing purifier column (Matheson Trigas). Potassium naphthalenide (KNAP) solution was prepared by mixing solid potassium metal (98% chunks in mineral oil, rinsed in cyclohexane prior to use) and a slight excess of recrystallized naphthalene under Ar in an air-free schlenk graduated cylinder in dry THF.

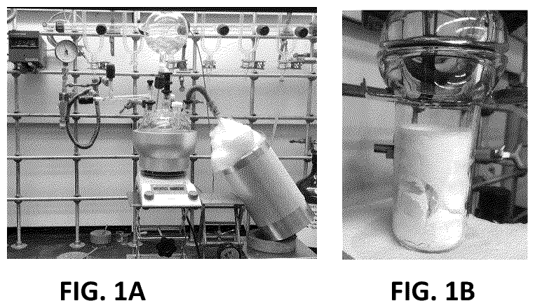

The synthetic apparatus is based on a multiport air-free glass reactor system that allows for the stepwise air-free addition of multiple monomer and initiators systems as shown in FIG. 1A.

### Molecular and Material Characterization

### NMR, Thermal Analysis, SAXS and XPS

¹H NMR spectra were collected in CDCl3 using a Bruker Advance NEO 400 MHz Spectrometer equipped with Prodigy BBFO cryo-probe (ns=256, 10 s delay for polymer samples). Thermal analysis was performed on a TA Instruments TGA Q500 and Discovery DSC 2500.

Synchrotron small angle x-ray scattering (SAXS) experiments were run at the 12-ID-B beamline at the Advanced Photon Source (Argonne, IL) for all neat polymer samples. All SAXS measurements utilized a beam energy of 13.30 keV (0.9322 Å) and were recorded by a Pilatus 2M detector (1475×1679 pixel resolution) at a sample-to-detector distance of 3.6 m. The scattering wave vector, q, was calibrated using a silver behenate standard (d=58.38 Å). Samples were thermally processed for 15 minutes prior to SAXS measurements to initiate phase separation and minimize air bubbles. Dry polymer discs were sandwiched between Kapton tape and mounted to a multi-sample DSC pan holder made for the multi-sample heated stage. The samples remained at ambient pressure and were ramped between 100° C. and 200° C., with exposure times of 1 s for all data collected.

X-ray photoelectron spectroscopy measurements were conducted using a PHI Physical Electronics PE-5800 X-ray Photoelectron Spectrometer. All samples were thermally processed into flat rectangular 13 mm×4 mm×0.015 in coupons for 15 minutes prior to XPS measurements to initiate phase separation in the TPE networks. In addition to being thermally processed, the porous elastomer sample was also solvated in DI water to extract sacrificial SO from pore space prior to XPS measurements. All samples were dried and then analyzed on their exterior surface.

### Electronic Impedance Spectroscopy (EIS)

Impedance spectroscopy measurements on the SLMs were conducted using a 1287 Potentiostat/1260 FRA combination from Solartron in the 0.1 Hz-200 kHz range applying a 100 mV sinusoidal voltage. The samples, swollen gel disks, were heated under vacuum to 50° C. prior to the first cycle of EIS measurements and their impedance was measured periodically as the vacuum oven cooled to RT. The samples were heated to 80° C. under vacuum for the second cycle of measurements. The EIS measurements for all swollen gels were done using a reusable quick assembly split coin cell (20 mm I.D.) from MTI corporation. All EIS measurements for the RTIL were done using standard CR2032 SS316 coin cells using Viton gaskets and stainless-steel spacers and springs.

### Mechanical Characterization

### Uniaxial and Cyclical Uniaxial Tensile Testing

Cyclical uniaxial tensile testing was performed at room temperature on a tensile tester (Instron Model 4442 electromechanical universal testing system) fitted with pneumatic tensile grips (pressurized to 90 psig). All samples were thermally processed into 26 mm×7.5 mm×0.02 in rectangular coupons. The porous elastomer sample was also then solvated in DI water to extract sacrificial SO from pore space prior to mechanical testing. Once made porous the porous elastomer and the reference neat elastomer were dried and then punch into a dog bone shape (where the cross section of the narrow section was 2 mm×0.0.2 in), and then mounted in the grips with an initial gauge length of ˜9 mm between grips (measured once mounted). Samples were stretched at a strain rate of 2% strain per second from 0% to 100% strain for 10 consecutive cycles. The first cycles of each sample were highlighted separately to show the preconditioning tensile behavior of the neat and porous elastomers.

### Example 1: Synthesis of Polystyrene-OH (S—OH) Macroinitiator

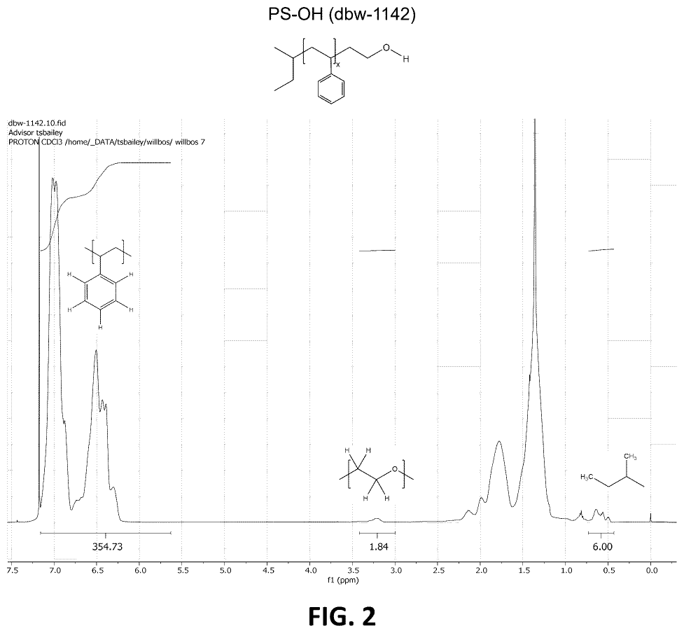

Synthesized of polystyrene-OH has been previously reported.^{1,2} A representative ¹H NMR for S—OH (dbw-1142) made by this method is provided in FIG. 2.

### Example 2: Synthesis of Polystyrene-b-poly(ethylene oxide)-H, (SO—H)

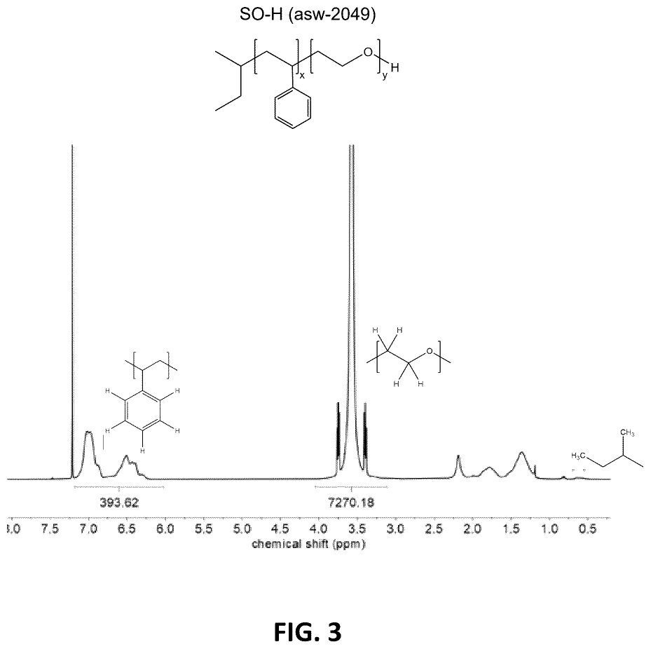

This procedure is a modification of synthetic methods originally published in 2010 by Guo and Bailey.¹ A 2 L air-free reaction vessel fitted with glass stir bar, pressure gauge, transfer arm, and 1 L solvent bulb was filled with dry, unstabilized tetrahydrofuran (THF), was evacuated and backfilled with Ar gas five times. Under positive Ar pressure (1 psig), 1.729 g (0.216 mmol) of S—OH macroinitiator was added to the reactor. The reactor was evacuated and backfilled five more times and then evacuated overnight to ensure dryness of the S—OH. After backfilling with Ar (−3.5 psig), the THF was added to the reactor to dissolve the S—OH. The reactor was heated to 45° C. and then titrated (via 5 mL airtight glass Hamilton syringe) with concentrated KNAP until a light green color persisted in the reactor for approximately 20 minutes. After reducing the reactor pressure to −3.5 psig, 17.15 g (0.389 mol) of purified ethylene oxide monomer (EO, maintained at 0° C.) was added via air-free glass buret. The reaction was stirred for 24 hrs. The reaction was then allowed to cool to room temp, vented for 20 min, and terminated with −2 mL of 0.1 N HCl. The reaction was reduced to −0.6 L via rotary evaporator, precipitated into 4 L of pentane, and recovered using vacuum filtration. Finally, the product (asw-2049) was fully dried under vacuum at ambient temperature for two days. Yield (SO—H)=16.83 g, 89.1% yield, FIG. 3 shows a representative ¹H NMR spectra.

### Example 3: Synthesis of a “One-Pot” Polymerization of Polystyrene-b-poly(ethylene oxide)-b-polystyrene (ASW-2066)

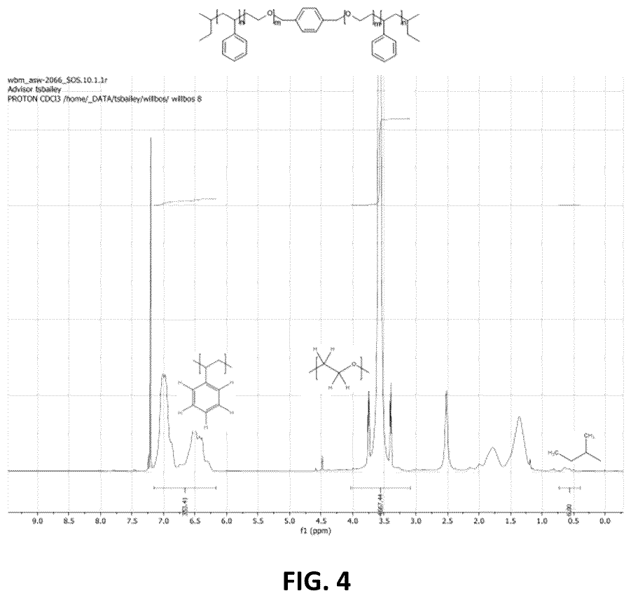

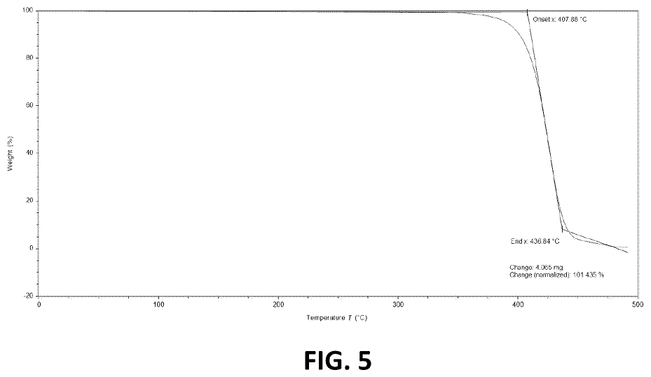

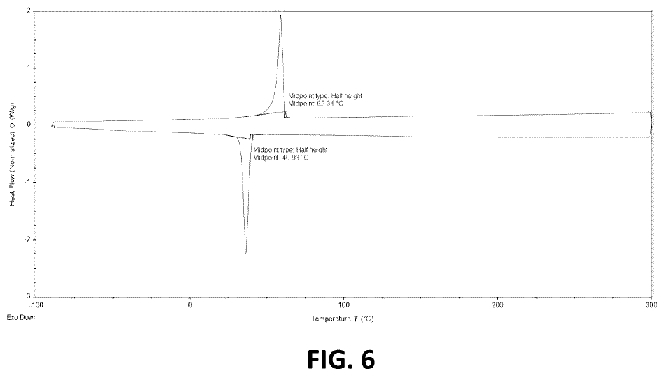

A 2 L air-free reaction vessel fitted with glass stir bar, pressure gauge, transfer arm, and 1 L solvent bulb filled with dry, unstabilized THF, was evacuated and backfilled with Ar gas five times. Under positive Ar pressure (1 psig), 1.56 g (0.195 mmol) of PS—OH macroinitiator was added to the reactor. The reactor was evacuated and backfilled five more times and then evacuated overnight to ensure dryness of the S—OH. After backfilling with Ar (˜3.5 psig), the THF was added to the reactor to dissolve the S—OH. The reactor was heated to 45° C. and then titrated (via 5 mL airtight glass Hamilton syringe) with concentrated KNAP until a light green color persisted in the reactor for approximately 20 minutes. After reducing the reactor pressure to ˜3.5 psig, 15.3 g (0.347 mol) of purified ethylene oxide monomer (EO, kept at 0° C.) was added via air-free glass buret. The reaction was stirred for 24 hrs. The reactor was then cooled for 1 hour prior to venting reactor with a needle and positive Ar pressure to remove unreacted EO without exposing reactor to air. The reactor was sealed again and re-titrated with a fresh solution of concentrated KNAP using a glass syringe. 0.858 g (3.25 mmol) recrystallized α,α′-dibromo-p-xylene (DBX, Tokyo Chemical Industry Co., Ltd.) was dried in a 100 mL purification flask for 20 min. Dry THF was added to the purification flask via cannula and the solution was weighed so the concentration was known. The total amount of KNAP required to titrate the reaction (titration #1 and #2) was used to calculate the amount of DBX (0.5 equivalents per K) to add to the reaction. 5.23 mL of DBX solution (0.325 mmol DBX) were added to the reactor via syringe pump over 10 hours. The reaction was reduced to 500 mL with rotary evaporation, precipitated into 3.5 L of pentane, and recovered using vacuum filtration. Finally, the product was fully dried under vacuum at ambient temperature for two days. FIG. 4 shows the ¹H NMR spectrum. FIG. 5 shows a thermal gravimetric analysis (TGA) spectrum. FIG. 6 shows a differential scanning calorimetry (DSC) spectrum.

### Example 4: Characterization of a Polystyrene-b-Polybutadiene-b-Polystyrene (SBS) TPE (Kraton D-1102)

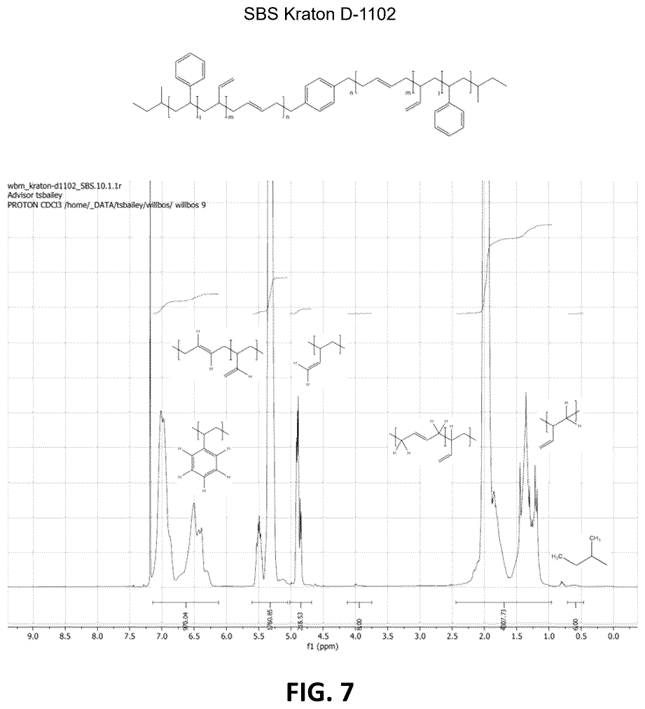

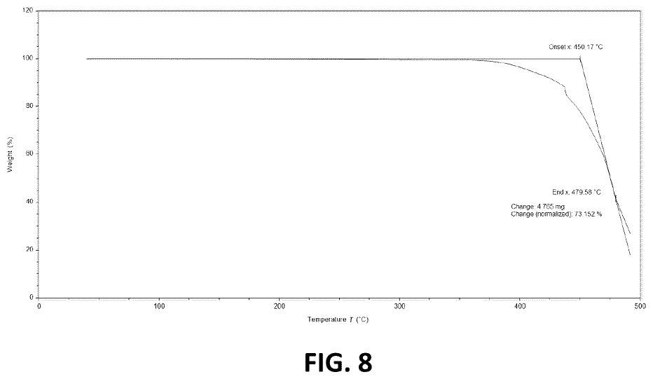

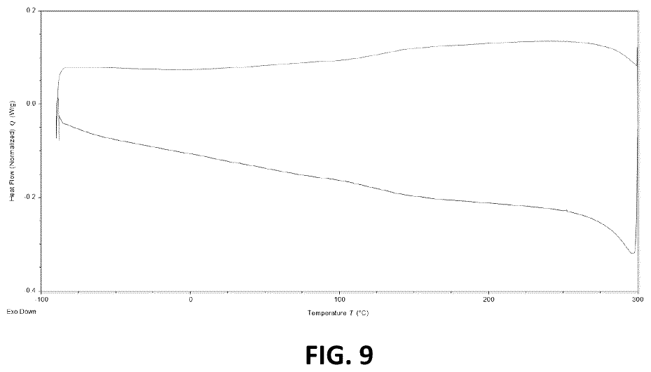

The characterization of the SBS TPE was accomplished using ¹H NMR, thermal gravimetric analysis (TGA), and differential scanning calorimetry (DSC). FIG. 7 shows the ¹H NMR spectrum. FIG. 8 shows a thermal gravimetric analysis (TGA) spectrum. FIG. 9 shows a differential scanning calorimetry (DSC) spectrum.

### Example 5: Method of Formation of a Hydrophilic TPPE Precursor Dry Blend Through Dissolving in a Co-Solvent and Evaporative Drying

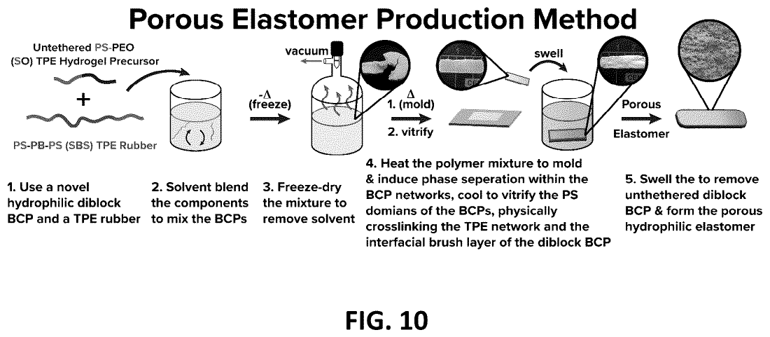

In one embodiment, TPPE precursor dry blends were made by blending 1 g of a styrenic block copolymer, SO, ASW-2049 and a 1 g of a styrenic TPE, Kraton D-1102 (SBS, triblock copolymer elastomer) together with benzene as a co-solvent. The benzene (50 mL) and the TPPE precursor dry blend components (1 g each) were added to a vacuum drying chamber that could be closed to air and attached to a vacuum line. While the vessel was open to air without being attached to the vacuum, the solution was stirred on a stir plate. Mixing proceeded until the polymers were fully dissolved in solution, stirring for about 2 hours total. Once the components were well incorporated, the solution was then frozen by submerging in liquid nitrogen for 15 to 20 minutes, vitrifying the mixture. To sublimate the benzene, the vessel was connected to the vacuum line and pumped down to a pressure of 15-30 mTorr. When the baseline pressure was reached, the liquid nitrogen was removed, and the benzene was sublimated out of the blend. The blend was then left under vacuum overnight to remove all the benzene. Once the TPPE precursor blend was dried, it was a light and fluffy powder and was placed in a freezer at 2° C. to be stored for future use. Once solvent blending was complete the TPPE precursor dry blend was ready to be melt processed, as shown in FIG. 1B and FIG. 10.

### Example 6: Method of Preparing a Hydrophilic TPPE Precursor Composite Using Heat and Pressure

In one embodiment, TPPE precursor dry blends were thermally processed using a Carver Model CH manual hydraulic press and stainless-steel rectangular molds (26 mm×7.5 mm×0.5 mm or 17 mm×6 mm×0.5 mm) or 3D printed molds for complex geometries. Samples were packed (overfilled by 50% more mass than required) into the mold that was placed on FEP coated Kapton FN (Dupont, 500FN131). Another sheet of Kapton was added on top of the mold and everything was placed between pre-heated aluminum plates in the melt press. The mold was heated to a temperature of 150° C. with slight pressure for 5 minutes. Then a pressure of 10,000 lbf was applied to a TPE dry blend containing 50% ASW-2006 SOS TPE and 50% SBS TPE rubber (D-1102) for 2 minutes to remove any trapped air bubbles in the sample. Samples were taken out of the melt press and allowed to cool to room temperature before being removed from the molds. If bubbles were still present in the sample after removing from the melt press, the sample was placed back and a greater pressure of 15,000 lbf was applied for another two minutes. Samples ranged from 7 to 11 minutes in the melt press to remove all bubbles.

In one embodiment, TPPE precursor dry blends were thermally processed using a Thermo Scientific MiniJet Pro injection molder and a stainless-steel rectangular injection mold (26 mm×7.5 mm×0.5 mm) or a 3D printed injection molds made with FormLabs Rigid 10k resin with a Form 3 SLA printer for complex geometries. Samples were packed (overfilled by 50% more mass than required) into the injection cylinder and heated to 150° C. for 5 minutes, while simultaneously the empty injection mold was pre-heated to 50° C. An injection pressure of 300 bar was applied to the polymer blend for 5 seconds and a hold pressure of 200 bar was applied for an additional 10 seconds. The injection mold was then removed and cooled for 20 minutes to allow for vitrification of the TPPE precursor composite.

### Example 7: Method of Preparing a Hydrophilic TPPE Precursor Composite Using Heat and Mechanical Mixing (Micro Compounding)

In one embodiment, The TPPE precursor dry blends were thermally processed using a Thermo Scientific HAAKE MiniLab 3 Micro Compounder. The TPPE precursor dry blend was heated to 150° C. under a nitrogen atmosphere while mixing at a screw speed of 150 rpm, circulating for 10 minutes before being extruded into a cylindrical filament, where it then cooled to room temperature and vitrified to form the TPPE precursor composite.

### Example 8: Method of Removing the Hydrophilic Diblock Copolymer by Solvating with Deionized Water to Form the Hydrophilic Porous Elastomer

Thermally processed TPPE precursor composites were placed into an excess of DI water and allowed to soak for 72 hours. During the soaking time, the unbound SO diblock copolymer was removed by solvation, leaving bound SO coating the pore surfaces producing a hydrophilic PEO brush layer within the pores of the porous elastomer matrix. After fabrication of the hydrophilic porous elastomer, the sample was completely dried for 48 hours and then weighed. The sample is then rehydrated and weighed again to see the change in weight contributed by the water uptake into the pore space of the material. The hydrophilic porous elastomers were then characterized according to the following formulae: Water content [wt. %]=(Mw−Md)/Mw*100%, Swelling Ratio (Q)=(Mw−Md)/Md*100%. Where Mw is the mass of the swollen gel and Md is the mass of the dry polymer composite.

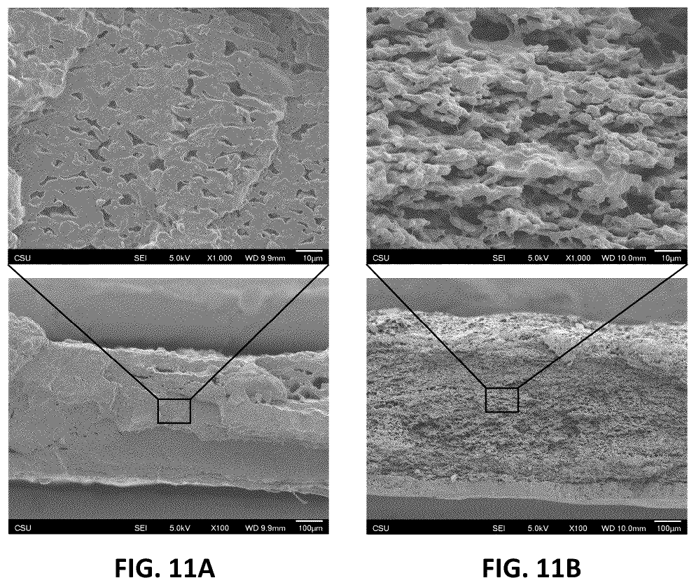

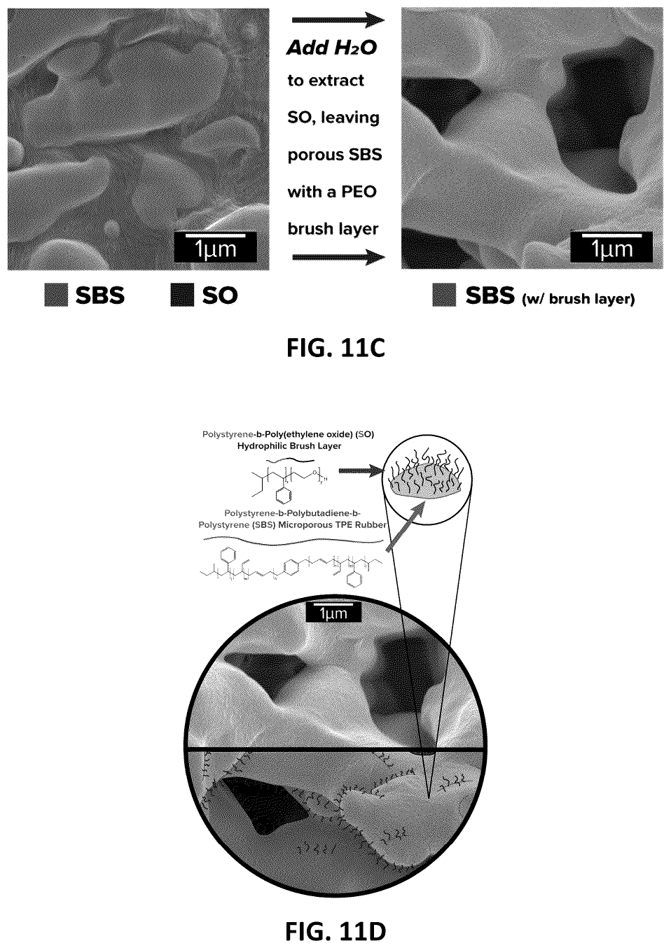

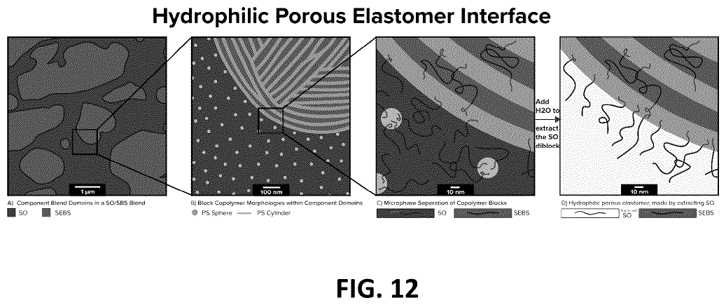

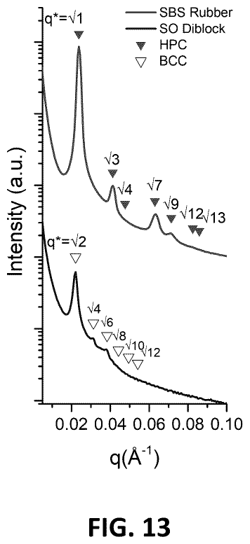

Scanning Electron Microscopy (SEM) images were used to characterize the pore structure of the hydrophilic porous elastomer made of SO (ASW-2049) and of SBS (D-1102) blended in benzene formed by melt processing in a manual hydraulic press, followed by removal of the unbound SO with DI water. In one embodiment, FIG. 11A shows the pore microstructure of a hydrophilic porous elastomer (WBM-2093) made of 0.5 g of SO (ASW-2049) and 1.5 g of SBS (D-1102) blended in 50 mL of benzene at 100× and 1000× magnifications. In another embodiment, FIG. 11B shows the pore microstructure of a hydrophilic porous elastomer (WBM-2090) made of 1 g of SO (ASW-2049) and 1 g of SBS (D-1102) blended in 50 mL of benzene at 100× and 1000× magnifications. These SEM images of the two different compositions used to make hydrophilic porous elastomers demonstrate the tunability of pore size and continuity based on the relative ratio of the sacrificial SO component to the SBS component. FIG. 11C demonstrates the transformation from the TPPE precursor composite formed by 1 g of SO (ASW-2049) and 1 g of SBS (D-1102) into a hydrophilic porous elastomer by washing with water. FIG. 11D and FIG. 12 describe pictorially the bound SO (ASW-2049) diblock copolymer forming a dense polymer brush coating the porous SBS (D-1102) elastomer matrix left behind after the washing step. Small angle X-ray scattering (SAXS) was also used to characterize the structure internal to the individual TPE domains. FIG. 13 provides the SAXS data characterizing the morphology of the self-assembled TPE domains. Neat SO diblock exhibits a body-centered cubic phase separation morphology and neat SBS elastomer exhibits a hexagonally packed cylinder morphology.

### Example 9: Measuring the Tensile Properties of the Porous Elastomers

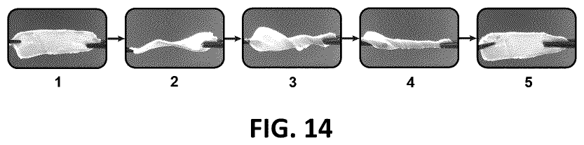

A series of photos showing a visual demonstration of twisting a hydrophilic porous elastomer (WBM-2093) made of 25% SO (ASW-2049) and 75% SBS (D-1102) blended in benzene, thermally pressed using a manual hydraulic press, and solvated to remove the sacrificial SO component is shown in FIG. 14. The hydrophilic porous elastomer is shown to twist several times and return to its original state without signs of fracture or permanent deformation.

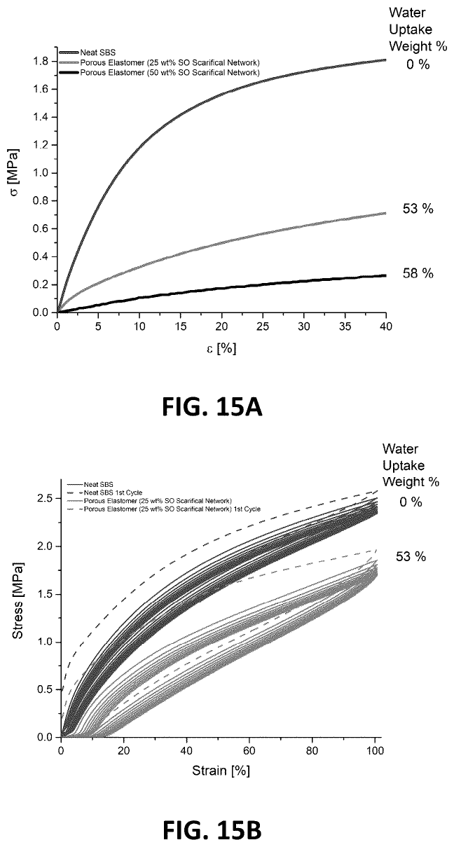

These samples were then evaluated using uniaxial and cyclic uniaxial tensile testing. FIG. 15A shows tensile extension at 2% strain per second to 40% strain comparing neat SBS rubber to two porous elastomer samples with varying pore sizes. FIG. 15B shows cyclic tensile loading at 2% strain per second and unloading to 100% strain for 10 consecutive cycles comparing neat SBS rubber to the porous elastomer made from a TPPE precursor composite comprised of 25% SO. The porous elastomer shows similar elastic and plastic behavior compared to non-porous, hydrophobic SBS.

### Example 10: Method of Using ¹H NMR to Evaluate the Composition of a Hydrophilic Porous Elastomer

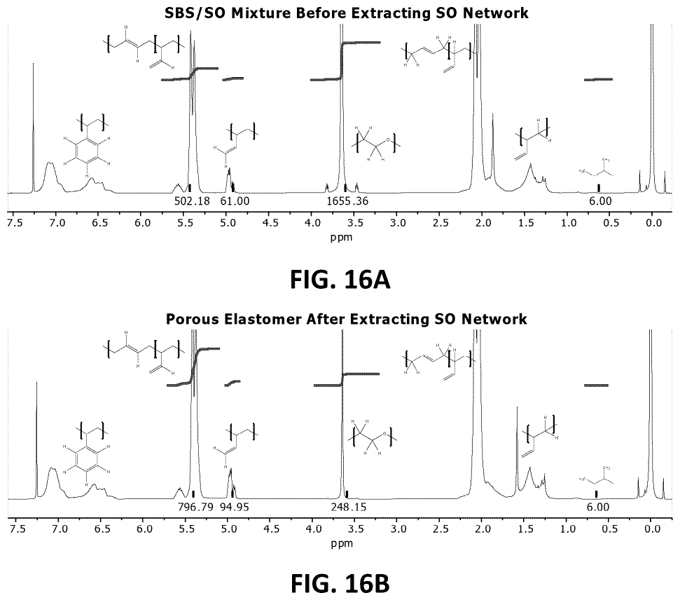

Proton nuclear magnetic resonance (¹H NMR) analysis was done on the hydrophilic porous elastomer (WBM-2090) for compositional analysis of the porous elastomer before and after removal of the SO component. FIG. 16A shows ¹H NMR spectra of the SBS/SO mixture (SO network intact, before extracting) and FIG. 16B shows the porous elastomer (SO network removed, after extracting). The decreased ratio of the butadiene (B) protons relative to the ethylene oxide (EO) protons (from 1.6:1—EO:B to 0.15:1—EO:B), confirms 90% removal of the SO component, but the continued presence of the EO peak confirms there is still SO component in the material.

### Example 11: Method of Using XPS to Evaluate the Composition of a Hydrophilic Porous Elastomer

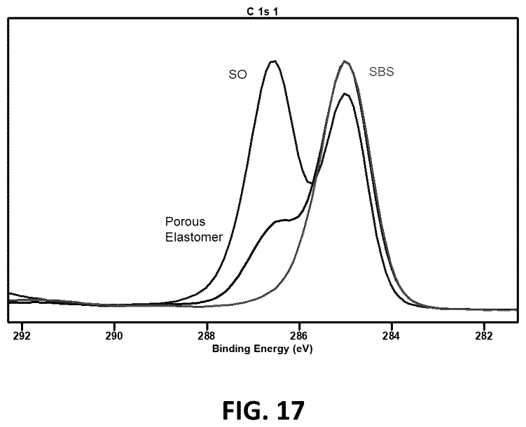

X-ray photoelectron spectroscopy (XPS) was used for elemental characterization of the hydrophilic porous elastomer (WBM-2090) made of 50% SO (ASW-2049) and 50% SBS (D-1102) compared to the neat components as reference shown in FIG. 17. The presence of the ether peak in the porous elastomer spectrum indicates PEO from the SO component is still present at the surface of the porous elastomer even after removing SO domains by solvation to create pore space in the elastomer network.

### Example 12: Method of Swelling in Dyed DI Water to Analyzing the Swelling Behavior of a Hydrophilic Porous Elastomer

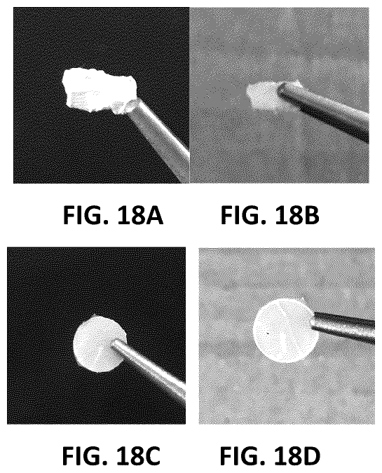

Swelling characterization photographs of the hydrophilic porous elastomer (WBM-2090) made of 50% SO (ASW-2049), 50% SBS (D-1102) were compared to 100% neat SBS (D-1102) are given in FIG. 18A, 18B, 18C, 18D. This swelling test was done to visualize the swelling of a hydrophilic porous elastomer, blue dye was placed in the swelling water. FIG. 18A and FIG. 18C show the porous elastomer and SBS before being placed in DI water dyed blue for 48 hours. FIG. 18B shows the porous elastomer absorbed water into the pore space, seen by the color change in the sample and the change in the mass measurements before and after swelling. The porous elastomer was found to have increased in weight by 58% after being swelled. The neat SBS control image, FIG. 18D, shows no color change after soaking in blue dye, indicating that SBS didn't stain blue or absorb dyed water. The before and after swelling mass measurements confirm that there was no change in mass in the neat SBS after soaking for 48 hours. This confirms that the water absorption seen in the porous elastomer was likely due to a hydrophilic PEO brush layer present on the surfaces of the pores in the elastomer.

### REFERENCES

The entirety of the disclosures of the following references, and any other reference disclosed herein, are incorporated herein by reference.
1. C. Guo and T. S. Bailey, Soft Matter, 2010, 6, 4807-4818, DOI:10.1039/c0sm00139b
2. B. Wijayasekara, M. G. Cowan, J. T. Lewis, D. L. Gin, R. D. Noble and T. S. Bailey, J. Memb. Sci., 2016, 511, 170-179, DOI:10.1016/j.memsci.2016.03.045

1.-35. (canceled)

36. A method for preparing a porous elastomer, the method comprising:
(a) providing a thermoplastic porous elastomer (TPPE) precursor composite wherein the TPPE precursor composite comprises a styrenic block copolymer and styrenic thermoplastic elastomer;
(b) washing the TPPE precursor composite in a liquid medium to remove unbound styrenic block copolymer and to form the porous elastomer; and
(c) drying the porous elastomer to remove any residual wash liquid.

37. The method of claim 36, wherein the provision of the TPPE precursor composite (a) includes:
(i) contacting the styrenic block copolymer and the styrenic thermoplastic elastomer to form a TPPE precursor composite dry blend;
(ii) heating the TPPE precursor composite dry blend to form a TPPE precursor composite melt; and
(iii) cooling the TPPE precursor composite melt to ambient temperature to form the TPPE precursor composite of the styrenic block copolymer and the styrenic thermoplastic elastomer.

38. The method of claim 37, wherein the styrenic thermoplastic elastomer in the TPPE precursor composite or the TPPE precursor composite is chemically crosslinked.

39. The method of claim 36, wherein the washing (b) is performed at a temperature within a range of about −10° C. to about 160° C.

40. The method of claim 36, wherein the liquid medium is an aqueous medium comprising at least one of an aqueous solvent, an aqueous electrolyte, or combinations thereof.

41. The method of claim 36, wherein the liquid medium comprises one or more of a non-aqueous solvent, a non-aqueous liquid electrolyte, or a combination thereof.

42. The method of claim 37, further comprising forming wherein the TPPE precursor composite dry blend by dissolving the styrenic block copolymer and the styrenic thermoplastic elastomer in a solvent and removing the solvent.

43. The method of claim 37, further comprising forming the TPPE precursor composite dry blend by heating the styrenic block copolymer and the styrenic thermoplastic elastomer to a temperature between about 80° C. and 320° C.

44. The method of claim 37, further comprising forming the TPPE precursor composite dry blend by heating the styrenic block copolymer and the styrenic thermoplastic elastomer for between about 5 minutes and 60 minutes.

45. The method of claim 37, wherein the heating (ii) of the TPPE precursor composite dry blend is conducted in the presence of applied pressure between about 1000 lbf and 25000 lbf.

46. The method of claim 37, wherein the heating step (ii) further comprises at least one of mechanical mixing, compounding, or extrusion.

47. The method of claim 46, wherein heating step (ii) comprises mechanical mixing with at least one screw, with a mixing speed between about 50 rpm and 250 rpm.

48. The method of claim 36, wherein the TPPE precursor composite has a microstructure comprising a block copolymer domain and a thermoplastic elastomer domain.

49. The method of claim 36, wherein the porous elastomer retains a porous structure after the drying (c).

50.-57. (canceled)

58. The method of claim 48, wherein a size of the block copolymer domain and a size of the thermoplastic elastomer domain are each within a range of about 0.1 microns to about 10 microns.

59. The method of claim 48, wherein a size of the block copolymer domain and a size of the thermoplastic elastomer domain are each within a range of about 0.1 microns to about 20 microns.

60. The method of claim 48, wherein a size of the block copolymer domain and a size of the thermoplastic elastomer domain are each within a range of about 0.1 microns to about 50 microns.

61. The method of claim 36, wherein the washing (b) involves removing and replacing the liquid medium at least twice.

62. The method of claim 36, wherein the porous elastomer comprises:
an elastomeric matrix with one or more pores, which comprises the thermoplastic elastomer; and
a surface coating bound to a surface of the one or more pores,
wherein the surface coating comprises the styrenic block copolymer.

63. The method of claim 48, wherein during the washing (b):
a portion of the styrenic block copolymer disposed at an interface of the block copolymer domain and the thermoplastic elastomer domain remains bound to the thermoplastic elastomer; and
the liquid medium solvates the unbound styrenic block copolymer to form a pore lined with a surface coating formed of the bound portion of the styrenic block copolymer.

64. A porous elastomer comprising:
an elastomeric matrix with one or more pores; and
a surface coating on the surface of the pores;
wherein:
the elastomeric matrix comprises a styrenic block copolymer and a styrenic thermoplastic elastomer;
the surface coating comprises the styrenic block copolymer; and
the styrenic block copolymer and the styrenic thermoplastic elastomer each independently comprise at least one non-hydrogenated or hydrogenated styrene block.

65. An article comprising:
a porous elastomer according to claim 64;
wherein the article is in a form selected from the group consisting of (i) a liquid phase separation membrane comprising the porous elastomer; (ii) a wound dressing comprising the porous elastomer; (iii) a tissue engineering scaffold comprising the porous elastomer; (iv) a coated surface comprising the porous elastomer applied to a polymer, glass, metal, ceramic, or composite surface; and (v) a supported liquid membrane comprising the porous elastomer saturated with a second liquid medium.
